(19) United States
(12) Patent Application Publication
(10) Pub. No.: US 2026/0268437 A1
(43) Pub. Date: Sep. 10, 2026

(54) EXEMPLAR-BASED OBJECT REPOSING USING GENERALIZED POSE CORRESPONDENCES

(71) Applicant: ADOBE INC., SAN JOSE, CA (US)

(72) Inventors: Sarthak Mehrotra, Bengaluru (IN); Rishabh Jain, Gurgaon (IN); Mayur Hemani, Noida (IN); Mausoom Sarkar, Noida (IN); Balaji Krishnamurthy, Noida (IN)

(21) Appl. No.: 19/074,544

(22) Filed: Mar. 10, 2025

(51) Int. Cl. G06T 3/18; G06T 7/73; G06T 11/00

(52) U.S. Cl. CPC G06T 3/18; G06T 7/74; G06T 11/10

(57) ABSTRACT

A method, apparatus, non-transitory computer readable medium, and system for image processing include obtaining a subject image and a pose image, where the subject image depicts an object and the pose image depicts a target pose, obtaining keypoint information that associates a part of the subject image and a corresponding part of the pose image, generating a flow map indicating a transformation of the part of the subject image by generating a plurality of flow map features at a plurality of different resolutions at different layers of the warping model, respectively, and generating a warped image based on the flow map and the subject image, where the warped image depicts the object with the target pose.

### BACKGROUND

The following relates generally to image processing, and more specifically to image generation using a machine learning model. Image processing refers to the use of a computer to edit an image using an algorithm or a processing network. In some cases, image processing software can be used for various image processing tasks, such as image restoration, image detection, image editing, image compositing, and image generation. For example, image generation includes the use of a machine learning model to generate a synthetic image based on an input such as a text prompt, an image, or a style. In some cases, image generation may include applications such as object reposing.

In the field of image generation, object reposing refers to the process of modifying the position, orientation, or pose of an object in an input image. For example, a machine learning model receives two input images (e.g., an original image depicting an object and a pose image depicting a different object having a different pose) and generates an output image that depicts the object from the original image having the pose from the pose image. However, in some cases, conventional systems are unable to generate an output image that can retain the visual features (e.g., color, texture, or shape) of the object depicted in the original image while performing the pose transfer to the object.

### SUMMARY

Embodiments of the present disclosure provide a method and system for image-to-image generation, and more specifically for object reposing. In one aspect, the system generates a synthetic image based on a subject image and a pose image. For example, the subject image depicts a first object having a first pose (e.g., orientation and position) and the pose image depicts a second object having a second pose. The system includes a keypoint detection model configured to generate a set of keypoint information based on the subject image and the pose image. The set of keypoint information represents the shared features between the first object and the second object. The system further includes a warping model trained to generate a flow map based on the subject image, the pose image, and the set of keypoint information. The flow map represents the transformation of features from the first object to the second object. In some aspects, the warping model applies the flow map to the subject image to generate a warped image, where the warped image depicts the first object having the second pose.

The system further includes an image generation model trained to generate a synthetic image based on the warped image. In one aspect, the image generation model includes a pair of U-Net encoder-decoder trained to generate the synthetic image based on the warped image and the keypoint information. The image generation model further includes a texture injection block configured to combine the features from the keypoint information to the features of the warped image, resulting in a synthetic image that retains the visual feature of the first object having the second pose.

A method, apparatus, non-transitory computer readable medium, and system for image processing include obtaining a subject image and a pose image, where the subject image depicts an object and the pose image depicts a target pose, obtaining keypoint information that associates a part of the subject image and a corresponding part of the pose image, generating, using a warping model, a flow map indicating a transformation of the part of the subject image by generating a plurality of flow map features at a plurality of different resolutions at different layers of the warping model, respectively, and generating a warped image based on the flow map and the subject image, where the warped image depicts the object with the target pose.

A method, apparatus, non-transitory computer readable medium, and system for image processing include obtaining a subject image and a pose image, where the subject image depicts an object and the pose image depicts a target pose, extracting keypoint information from the subject image and the pose image, where the keypoint information associates a part of the subject image and a corresponding part of the pose image, generating, using a warping model, a warped image based on the subject image, the pose image, and the keypoint information, where the warped image depicts the object with the target pose, and generating a refined image based on the keypoint information and the warped image.

An apparatus and system for image processing include a memory component, a processing device coupled to the memory component, the processing device configured to perform operations comprising, obtaining a subject image and a pose image, where the subject image depicts an object and the pose image depicts a target pose, obtaining keypoint information that associates a part of the subject image and a corresponding part of the pose image, generating, using a warping model, a flow map indicating a transformation of the part of the subject image by generating a plurality of flow map features at a plurality of different resolutions at different layers of the warping model, respectively, and generating a warped image based on the flow map and the subject image, where the warped image depicts the object with the target pose.

### BRIEF DESCRIPTION OF THE DRAWINGS

FIG. 1 shows an example of an image processing system according to aspects of the present disclosure.

FIG. 2 shows an example of a method for image generation according to aspects of the present disclosure.

FIG. 3 shows an example of a method for generating a warped image based on input images according to aspects of the present disclosure.

FIG. 4 shows an example of a method for generating the keypoint information according to aspects of the present disclosure.

FIG. 5 shows an example of a method for generating a refined image according to aspects of the present disclosure.

FIG. 6 shows an example of image-based pose transfer according to aspects of the present disclosure.

FIG. 7 shows an example of a machine learning system according to aspects of the present disclosure.

FIG. 8 shows an example of a keypoint detection model according to aspects of the present disclosure.

FIG. 9 shows an example of a warping model according to aspects of the present disclosure.

FIG. 10 shows an example of an image generation model according to aspects of the present disclosure.

FIG. 11 shows an example of a texture injection block according to aspects of the present disclosure.

FIG. 12 shows an example of a U-Net architecture according to aspects of the present disclosure.

FIG. 13 shows an example of training dataset preparation according to aspects of the present disclosure.

FIG. 14 shows an example of training a warping model according to aspects of the present disclosure.

FIG. 15 shows an example of training an image generation model according to aspects of the present disclosure.

FIG. 16 shows an example of a flow diagram depicting an algorithm as a step-by-step procedure in an example implementation of operations performable for training a machine learning model according to aspects of the present disclosure.

FIG. 17 shows an example of an image processing apparatus according to aspects of the present disclosure.

FIG. 18 shows an example of the machine learning model of the image processing apparatus according to aspects of the present disclosure.

FIG. 19 shows an example of a computing device according to aspects of the present disclosure.

### DETAILED DESCRIPTION

The following relates to image generation using a machine learning model. Embodiments of the present disclosure relate to an image generation system that accurately generates an output image depicting an object having a target pose based on an input image depicting the object and a pose image depicting the target pose. In one aspect, the system includes a keypoint detection model configured to obtain keypoint information that represents shared features from the input image and the pose image. The system further includes a warping model trained to generate a flow map that represents the transformation of the shared features from the input image to the pose image. By combining the input image with the flow map, the system ensures that the target pose can be accurately transformed onto the object depicted in the input image.

According to some embodiments, the system includes a keypoint detection model configured to generate key point information based on the input image and the pose image. For example, the input image (e.g., the subject image) depicts a first object having a first pose, and the pose image depicts a second object having a second pose (e.g., target pose). In some embodiments, the keypoint detection model generates a subject attention map and a subject saliency map based on the subject image. Additionally, the keypoint detection model generates a pose attention map and a pose saliency map based on the pose image. In an embodiment, the keypoint detection model performs a keypoint detection process to generate the keypoint information based on the subject attention map, subject saliency map, pose attention map, and pose saliency map. In one aspect, the keypoint information shared points between the first object and the second object that having substantially the same feature. By extracting the keypoint information from the input image and the pose image, the model can accurately identify the transformation of poses from the first object to the second object.

According to some embodiments, the system includes a warping model trained to generate a flow map based on the input image, the pose image, and the keypoint information. For example, the warping model includes a U-Net architecture trained to generate a plurality of flow maps at each layer of the U-Net to form a flow pyramid. As a result, the plurality of flows maps captures the pose transformation from the first object to the second object at different feature levels (e.g., different layers of the U-Net generate different levels of features). In one embodiment, each of the plurality of flow maps includes a different resolution and is upscaled to a same resolution. In one embodiment, the plurality of flow maps are combined to obtain a combined flow map. By applying the flow map to the input image, the warping model can accurately generate a warped image depicting the first object having the second pose.

According to some embodiments, the system further includes an image generation model trained to generate a synthetic image (or refined image) based on the warped image and the keypoint information. For example, the image generation model includes a pose encoder (e.g., a U-Net architecture), a texture encoder (e.g., a U-Net architecture), and a texture injection block. The pose encoder is trained to generate pose feature at different layers based on the keypoint information. The texture encoder is trained to generate texture feature at different layers based on the warped image. In some embodiments, the pose feature and the texture feature is added at each corresponding layer to generate a combined feature. By using the combined feature, the image generation model is able to preserve visual features of the first object having the second pose in the synthetic image.

A subfield in image generation relates to object reposing. Object reposing or pose transformation refers to the process of modifying the pose (e.g., a position, orientation, or posture) of an object from a first pose to a target pose. For example, pose transformation can be used to generate different views of an object depicted in an input image. Conventional systems generate the synthetic image using various methods such as relying on 3D models or using a diffusion model. However, these conventional techniques are unable to generate contents consistent with the input image, cannot be generalized, or unable to preserve fine details such as the texture or logos of object in the input image.

Some conventional systems uses a 3D rendering-based technique to generate a synthetic image having a different pose. For example, these systems use 3D models of an object to render images from different viewpoints and poses by applying transformation (e.g., rotation, scaling, or light modification) in a 3D graphic engine. In some cases, these systems are limited by the amount of training data. However, for most of the object depicted in an image, there is no corresponding 3D mode. As a result, these systems are unable to generalize to be rendered in practical use.

Some conventional systems integrate objects into masked portions of images by adjusting the geometry and color. For example, these systems utilize the thin-plate spline (TPS) warping and a generator to transfer object pose between images. In some cases, a spatial structural block is used to preserve spatial details and a text style block is used to maintain the appearance. However, these system require precise masks, where these systems fail to consider the size and shape of the object depicted in the image. As a result, these systems generate artifacts in masked regions, making the synthetic image less realistic.

Some conventional systems combines a diffusion based method to the mask-guided method in attempt to reduce the generation of artifacts. However, these systems generate images with distorted poses due to the inaccuracies in the spatial pose correspondence. Furthermore, these systems tend to hallucinate the text details in the generated regions.

Embodiments of the present disclosure improve on conventional image generation models by generating a synthetic image depicting an object that has a target pose more accurately. This is achieved using a system that includes a keypoint detection model configured to generate keypoint information based on an input image depicting a first object having a first pose and a pose image depicting a second object having a second pose, and a warping model trained to generate a flow map based on the input image, the pose image, and the keypoint information. In one aspect, the flow map represents the transformation of shared points from the first object to the second object. By applying the flow map to the input image, the system is able to accurately generate a warped image depicting the first object having the second pose. In some embodiments, the system further includes an image generation model trained to generate a refined image based on the features of the warped image and the keypoint information. By combining the features of the warped image and the keypoint information at each corresponding layer, the system is able to generate a refined image having preserved visual features (e.g., texture, color, etc.).

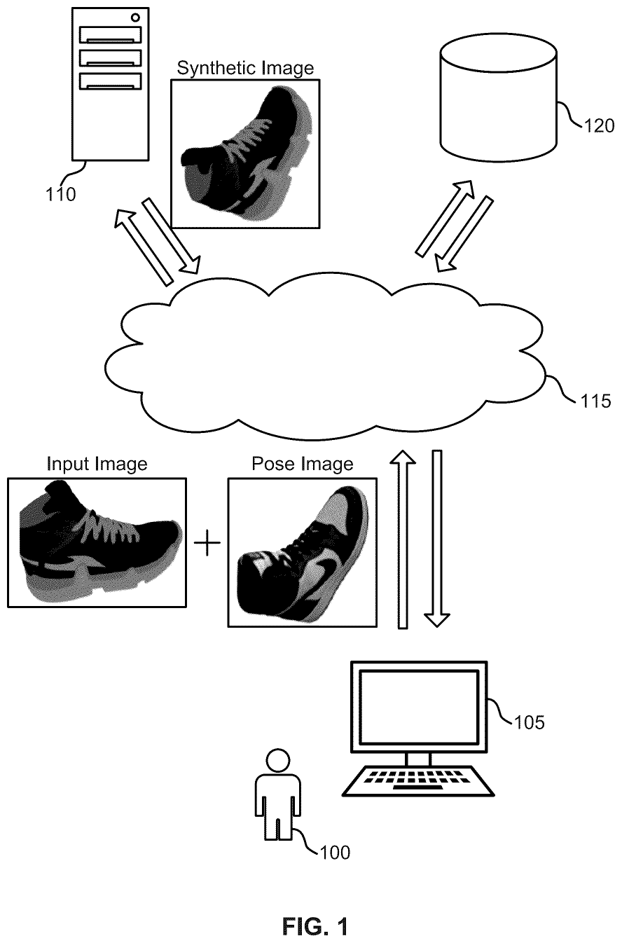

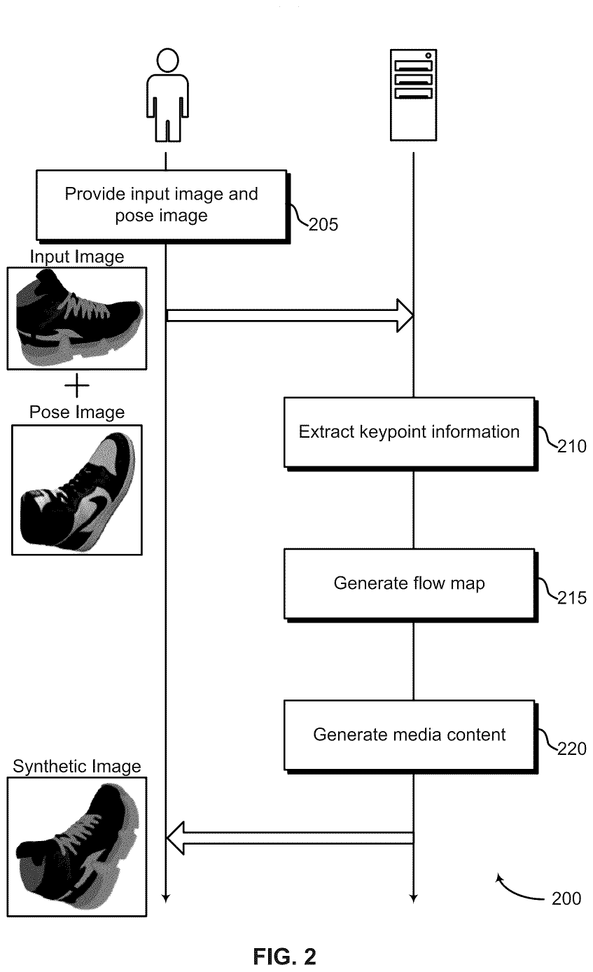

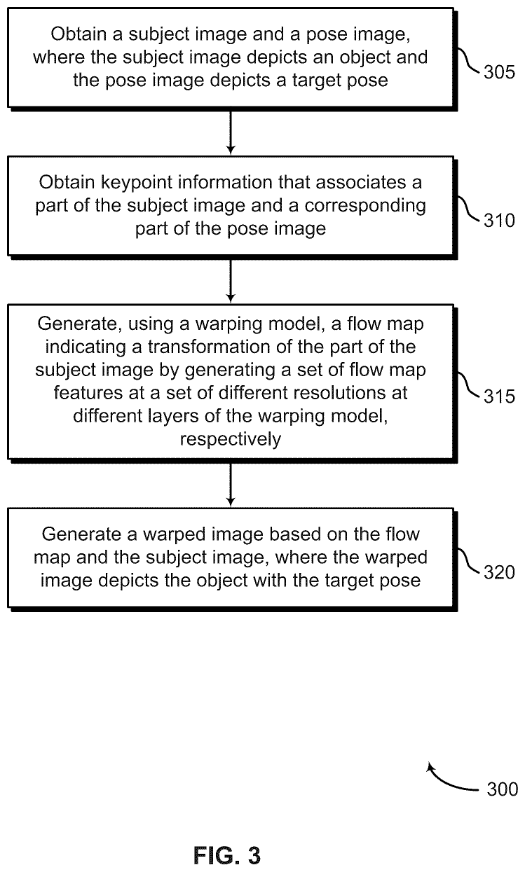

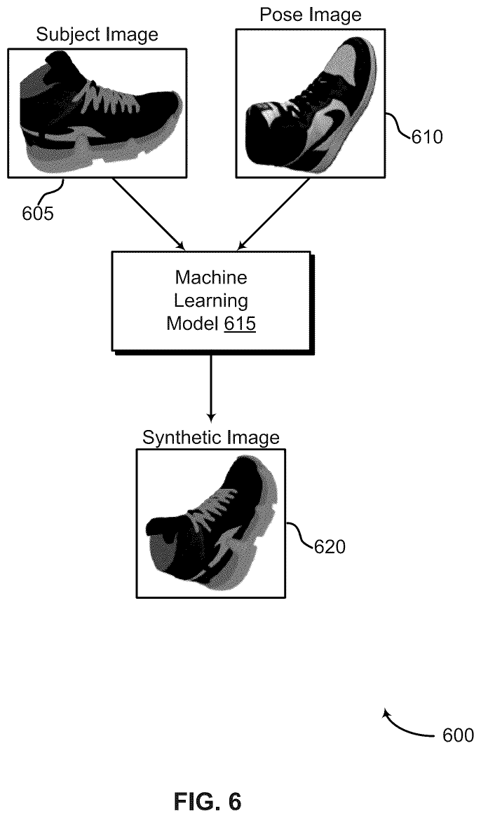

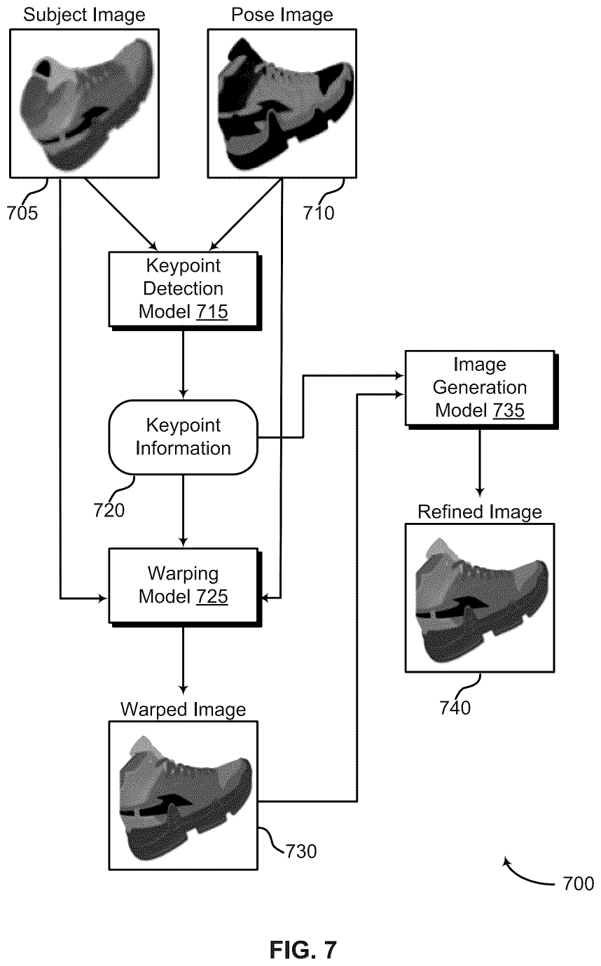

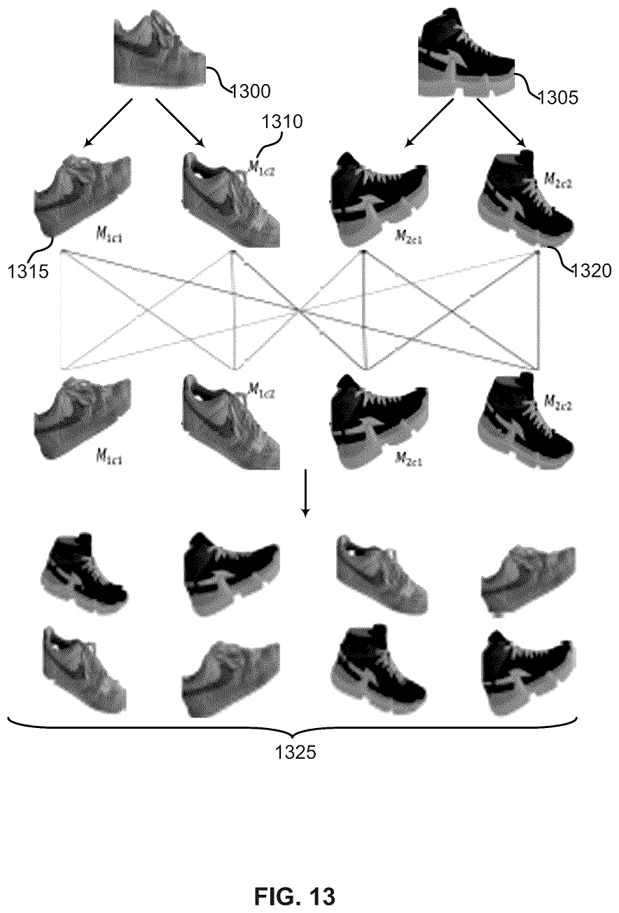

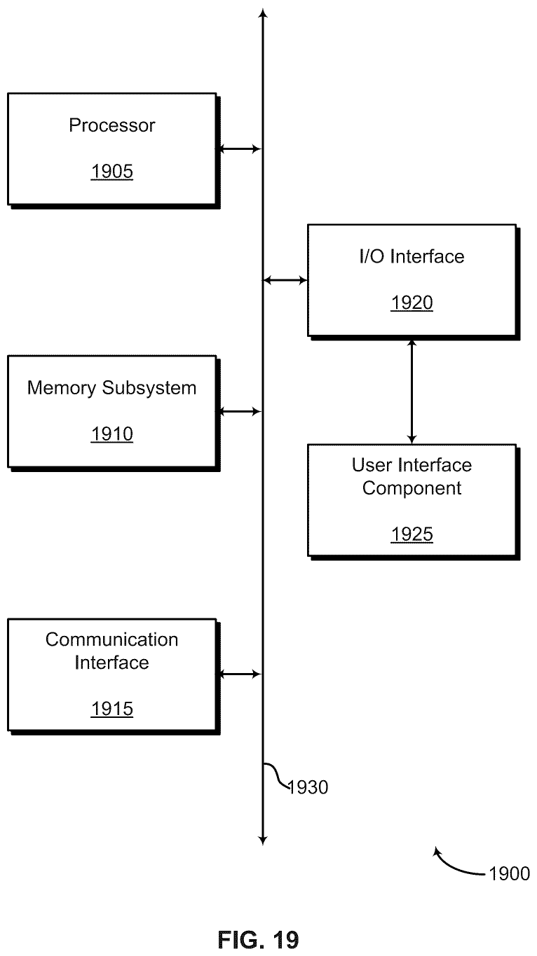

An example system of the present disclosure in image processing is provided with reference to FIGS. 1 and 19. An example application of the present disclosure in image processing is provided with reference to FIGS. 2 and 6. Details regarding the architecture of an image processing apparatus are provided with reference to FIGS. 7-12 and 17-18. An example of a process for image processing is provided with reference to FIGS. 3-5. A description of an example training process is provided with reference to FIG. 13-16.

Accordingly, the present disclosure provides a system and method that improves on conventional image generation systems by accurately generating a synthetic image depicting an object having a pose that aligns with the pose in a reference image. By generating the warped image instead of generating an image from a random noise or noisy image, the system ensures that the output image preserves the visual features (e.g., texture) of the object from the input image while having a second pose from the pose image. By generating keypoint information based on the input image and the pose image, the system can identify the shared features between the two objects depicted in the inputs, thus generating an output image reflecting the accurate pose transformation.

As described herein, the subject image is an input image that depicts a first object having a first pose. For example, the object may depict a car, a cat, a shoe, a glass, etc. A pose may refer to the position and orientation of the object in a 2D image. For example, the position of the object can be expressed using a coordinate system. The orientation represents the direction the object is facing and sometimes can be represented using a Euler angle.

The pose image is an input image that depicts a second object having a second pose different from the first pose. In some cases, the second object may be an object in the same class category as the first object. For example, when the subject image depicts a sneaker (e.g., a class category of a shoe), then the pose image may depict a leather shoe or a different sneaker. In some cases, the second pose is a target pose that the final image depicts.

Keypoint information may include a set of shared points between the subject image and the pose image. The set of share points may represent similar patterns, structures, point of interest, features, etc. For example, if the subject image depicts a first face and the pose image depicts a second face, then the keypoint information may include a set of points that represent common features between the two faces. For example, the set of points may be located at the forehead, eyes, nose, mouth, ear, cheek, etc.

A flow map represents the transformation of pixels of objects from one image to another image. For example, the transformation may include how each pixel from the subject image is shifted, warped, or transformed to align with the pose image. In some cases, the flow map includes the direction and magnitude of pixel movement. According to some embodiments, the system may generate a flow map at each layer, where the flow map captures the transformation of both coarse global transformation and fine-grained local transformation.

A warped image is an output image that depicts a transformed version of the subject image. For example, the warped image depicts the first object having the second pose. For example, when the subject image depicts a front view of a first face and the pose image depicts a second face looking in a direction, then the warped image depicts the first face looking in the same direction. In some cases, the warped image may capture the global feature (e.g., shape, color, texture, pose, etc.) of the subject image and the pose image.

An attention map may be referred to as a spatial feature descriptor, which is a numerical representation of localized visual features in an image. The attention map encodes key characteristics such as texture, shape, and structure from an input image. In some cases, the attention map may be generated from a tokenized image. For example, if an image has a dimension of 4×4, the system may generate 16 attention maps. Each of the attention maps captures the detail of local visual features.

A saliency map is a representation that highlights an important or attention-grabbing region of an input image. The saliency map is used to identify regions that a model or human vision system would focus on. For example, if an image depicts a bear in a forest, the saliency map may be a black-and-white image highlighting the bear. In some cases, the saliency map is used to identify a foreground object and a background scene.

Features, such as texture feature and pose feature, are numerical representations generated by a computer model (e.g., an encoder) that represents information of an object depicted in the input images. For example, the information may include patterns, textures, shapes, and structures. In some cases, these features are represented in a high-dimensional vector that compresses the input data while preserving important information. In some cases, the features generated at different layers of the encoder (or a U-Net structure) may include different types of information. For example, the low-level features generated at an early layer capture basic patterns like edges, corners, and textures. The mid-level features generated at an intermediate layer capture object parts, contours, and more complex features. The high-level features generated at deeper layers may capture the semantic of the input image such as the overall shape or category of an object depicted in the input image.

### Image Processing

In FIGS. 1-6, a method, apparatus, non-transitory computer readable medium, and system for image processing include obtaining a subject image and a pose image, where the subject image depicts an object and the pose image depicts a target pose, obtaining keypoint information that associates a part of the subject image and a corresponding part of the pose image, generating, using a warping model, a flow map indicating a transformation of the part of the subject image by generating a plurality of flow map features at a plurality of different resolutions at different layers of the warping model, respectively, and generating a warped image based on the flow map and the subject image, where the warped image depicts the object with the target pose.

Some examples of the method, apparatus, non-transitory computer readable medium, and system further include generating a first attention map and a second attention map based on the subject image and the pose image, respectively, where the keypoint information is based on the first attention map and the second attention map.

Some examples of the method, apparatus, non-transitory computer readable medium, and system further include generating a first saliency map and a second saliency map based on the subject image and the pose image, respectively, where the keypoint information is based on the first saliency map and the second saliency map.

In some aspects, the warping model is trained using a warping loss that includes a plurality of terms corresponding to the different layers of the warping model, respectively. Some examples of the method, apparatus, non-transitory computer readable medium, and system further include generating a refined image based on the keypoint information and the warped image.

Some examples of the method, apparatus, non-transitory computer readable medium, and system further include encoding the keypoint information obtain pose features. Some examples further include encoding the warped image to obtain texture features. Some examples further include combining the pose features and the texture features to obtain the refined image.

Some examples of the method, apparatus, non-transitory computer readable medium, and system further include injecting the texture features at each of a plurality of layers. Some examples further include generating a plurality of output images at the plurality of layers, respectively. Some examples further include combining the plurality of output images to obtain the refined image.

A method, apparatus, non-transitory computer readable medium, and system for image processing include obtaining a subject image and a pose image, where the subject image depicts an object and the pose image depicts a target pose, extracting keypoint information from the subject image and the pose image, where the keypoint information associates a part of the subject image and a corresponding part of the pose image, generating, using a warping model, a warped image based on the subject image, the pose image, and the keypoint information, where the warped image depicts the object with the target pose, and generating a refined image based on the keypoint information and the warped image.

Some examples of the method, apparatus, non-transitory computer readable medium, and system further include generating a flow map indicating a transformation of the part of the subject image by generating a plurality of flow map features at a plurality of different resolutions at different layers of the warping model, respectively.

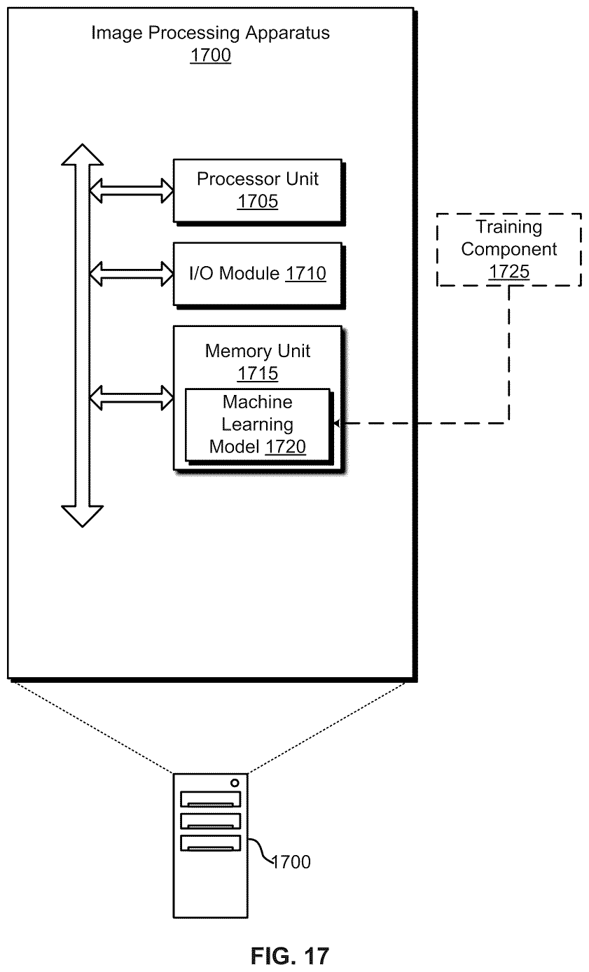

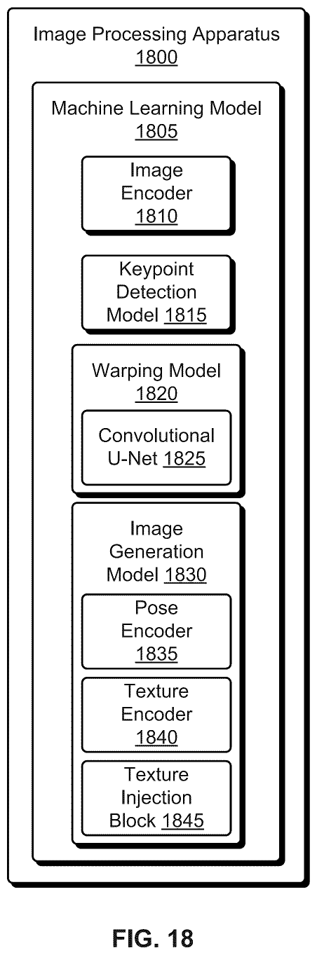

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIGS. 17 and 18.

Referring to FIG. 1, user 100 provides an input image (or a subject image) and a pose image to image processing apparatus 110 via user device 105 through cloud 115 to generate a synthetic image. In one aspect, the input image depicts a first object (e.g., a shoe) having a first pose (e.g., position and orientation). The pose image depicts a second object (e.g., a different shoe) different from the first object having a second pose. In some cases, the first object and the second object may be an object from the same class or category. For example, if the first image depicts a bird, then the second image may also depict a bird.

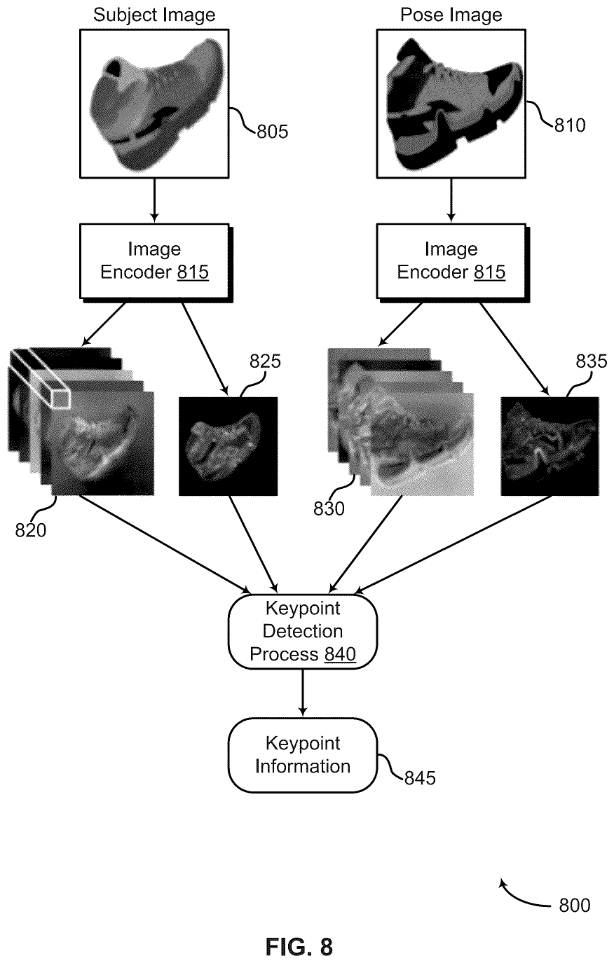

In one aspect, the image processing apparatus 110 includes a machine learning model that processes the inputs and generates a synthetic image (or an output image) depicting the first object having the second pose. The machine learning model includes a keypoint detection model that generates keypoint information based on the input image and the pose image. In some embodiments, an image encoder encodes the input image and the pose image to obtain a subject attention map and a pose attention map, respectively. Then, the keypoint detection model generates the keypoint information based on the subject attention map and the pose attention map. In one aspect, the keypoint information represents share points where the feature of the first object and the feature of the second object are substantially the same. Further detail on obtaining the keypoint information is described with reference to FIG. 8.

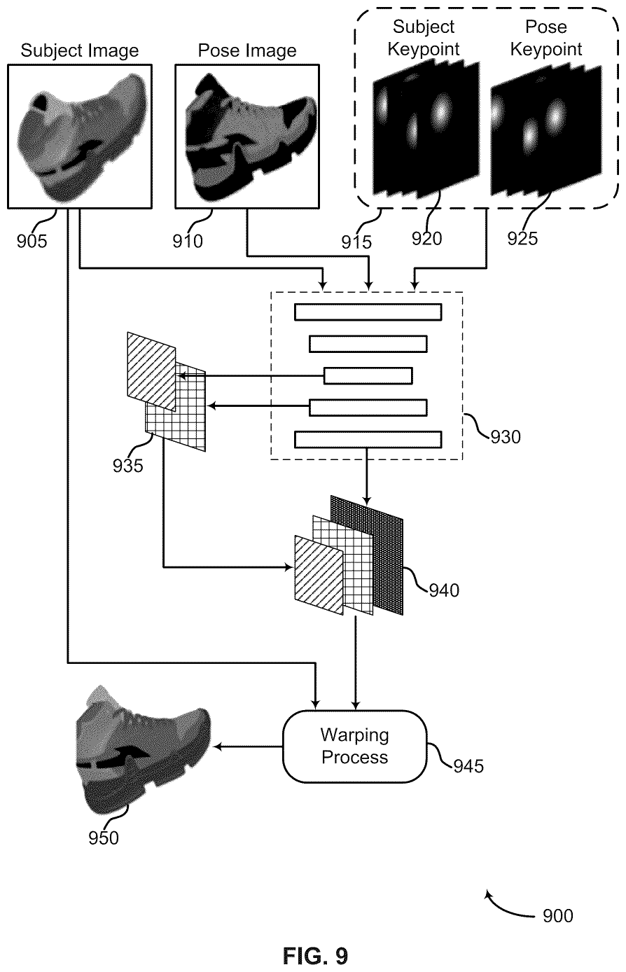

In some aspects, the machine learning model further includes a warping model trained to generate a warped image based on the input image, the pose image, and the keypoint information. For example, the warping model receives the input image, the pose image, and the keypoint information, and generates a flow map (or a flow pyramid) that represents the transformation of the share points from the first object to the second object. Then, the warping model further generates a warped image based on the input image and the flow map using a warping process, where the warped image depicts the first object having the second pose. Further detail on generating the warped image is described with reference to FIG. 9.

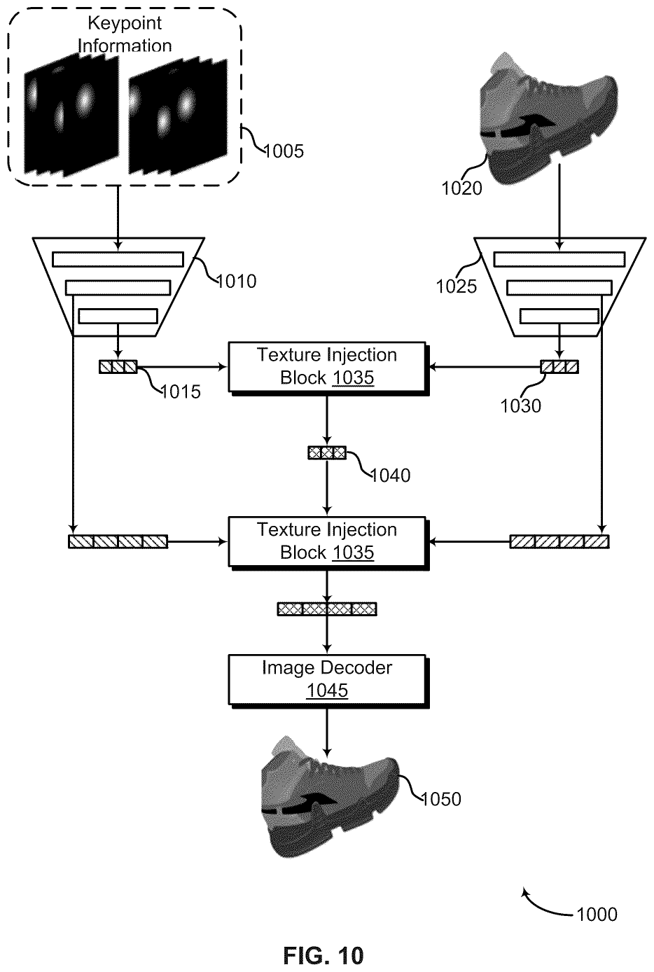

To enhance the image quality (e.g., preserving the visual features of the first object) of the warped image, the machine learning model further includes an image generation model trained to generate a refined image based on the warped image and the keypoint information. In some aspects, the image generation model includes a pose encoder (including a U-Net architecture) configured to generate a pose feature based on the keypoint information, and a texture encoder (including a U-Net architecture) configured to generate a texture feature based on the warped image. The pose feature and the texture feature are combined using a texture injection block to generate a combined feature, where the combined feature is decoded to generate the refined image. Further detail on the image generation model is described with reference to FIG. 10. In one aspect, the refined image depicts the first object having a second pose, where the visual feature of the first object from the input image is maintained in the refined image.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110. In some cases, user device 105 may include a user interface that performs functions of the image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIGS. 17 and 18. According to some aspects, image processing apparatus 110 includes a computer implemented network comprising a machine learning model, an image encoder, keypoint detection model, warping model, and an image generation model. Image processing apparatus 110 further includes a processor unit, a memory unit, an I/O module, a user interface, and a training component. In some embodiments, image processing apparatus 110 further includes a communication interface, user interface components, and a bus as described with reference to FIG. 19. Additionally or alternatively, image processing apparatus 110 communicates with user device 105 and database 120 via cloud 115. Further detail regarding the operation of image processing apparatus 110 is described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In some examples, cloud 115 is based on a local collection of switches in a single physical location.

According to some aspects, database 120 stores training data including a training subject image depicting a first object in a first pose, a training pose image depicting a second object in a second pose, and a ground-truth image depicting the first object in the second pose. In some aspects, database 120 stores output generated from the image processing apparatus 110. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 205, the system provides an input image and a pose image. In some cases, the operations of this step refer to, or may be performed by, a user as described with reference to FIG. 1. For example, the input image depicts a first shoe in a first pose and the pose image may depict a second shoe in a second pose. In some cases, the first shoe and the second shoe may have different color configurations, textures, shapes, designs, etc. In some cases, the input image may be referred to as the subject image.

At operation 210, the system extracts keypoint information. In some cases, the operations of this step refer to, or may be performed by, an image processing apparatus as described with reference to FIGS. 1, 17, and 18. In some cases, the operations of this step refer to, or may be performed by, a keypoint detection model as described with reference to FIGS. 7, 8, and 18. According to some embodiments, a keypoint detection model receives the subject image and the pose image to generate a first attention map and a second attention map, respectively. The attention maps capture visual features depicted in the subject image and the pose image. In some embodiments, the keypoint detection model further generates a subject saliency map and a pose saliency map based on the subject image and the pose image, respectively. Each of the saliency map depicts a region of interest in the subject image and the pose image. The keypoint detection model generates the keypoint information based on the first attention map, the subject saliency map, the second attention map, and the pose saliency map. Further detail on extracting the keypoint information is described with reference to FIG. 8.

At operation 215, the system generates a flow map. In some cases, the operations of this step refer to, or may be performed by, an image processing apparatus as described with reference to FIGS. 1, 17, and 18. In some cases, the operations of this step refer to, or may be performed by, a warping model as described with reference to FIGS. 7, 9, 14, and 18. The warping model is trained to generate a flow map that represents the pixel transformation between the subject image and the pose image. In an embodiment, the warping model receives the subject image, the pose image, and the keypoint information to generate a flow map. In some cases, the flow map may be a flow pyramid. The flow map may include a plurality of flow maps generated at different layers of a convolutional U-Net of the warping model. In an embodiment, the flow map is applied to the subject image to generate a warped image. Further detail on the flow map is described with reference to FIG. 9.

At operation 220, the system generates media content. In some cases, the operations of this step refer to, or may be performed by, an image processing apparatus as described with reference to FIGS. 1, 17, and 18. In some cases, the operations of this step refer to, or may be performed by, an image generation model as described with reference to FIGS. 7, 10, 15, and 18. In some embodiments, the image generation model receives the keypoint information and the warped image to generate a refined image (e.g., the media content). For example, the image generation model includes a pose encoder trained to generate pose features based on the keypoint information. The image generation model also includes a texture encoder trained to generate texture features based on the warped image. The image generation model also includes a texture injection block configured to combine the pose features and the texture features to generate a combined feature at each layer. The image generation model decodes the combined feature to generate the refined image (e.g., the media content). Further detail on generating the media content is described with reference to FIG. 10.

FIG. 3 shows an example of a method 300 for generating a warped image based on input images according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 305, the system obtains a subject image and a pose image, where the subject image depicts an object, and the pose image depicts a target pose. In some cases, the operations of this step refer to, or may be performed by, a warping model as described with reference to FIGS. 7, 9, 14, and 18. The subject image is an input image that depicts a first object in a first pose. For example, the object may depict a car, a cat, a shoe, a glass, etc. A pose may refer to the position and orientation of the object in a 2D image. For example, the position of the object can be expressed using a coordinate system. The orientation represents the direction the object is facing and can sometimes be represented using Euler angles.

The pose image is an input image that depicts a second object in a second pose, different from the first pose. In some cases, the second object may be an object in the same class category as the first object. For example, when the subject image depicts a sneaker (e.g., a class category of a shoe), the pose image may depict a leather shoe, or a different sneaker. In some cases, the second pose is a target pose that the final image depicts.

At operation 310, the system obtains keypoint information that associates a part of the subject image and a corresponding part of the pose image. In some cases, the operations of this step refer to, or may be performed by, a warping model as described with reference to FIGS. 7, 9, 14, and 18. Keypoint information may include a set of shared points between the subject image and the pose image. The set of share points may represent similar patterns, structures, point of interests, features, etc. For example, if the subject image depicts a first face and the pose image depicts a second face, then the keypoint information may include a set of points that represent common features between the two faces. For example, the set of points may be located at the forehead, eyes, nose, mouth, ears, cheeks, etc.

At operation 315, the system generates, using a warping model, a flow map indicating a transformation of the parts of the subject image by generating a set of flow map features at a set of different resolutions at different layers of the warping model, respectively. In some cases, the operations of this step refer to, or may be performed by, a warping model as described with reference to FIGS. 7, 9, 14, and 18. A flow map represents the transformation of pixels of objects from one image to another image. For example, the transformation may include how each pixel from the subject image is shifted, warped, or transformed to align with the pose image. In some cases, the flow map includes the direction and magnitude of pixel movement. According to some embodiments, the system may generate a flow map at each layer, where the flow map captures the transformation both coarse global transformation and fine-grained local transformation.

At operation 320, the system generates a warped image based on the flow map and the subject image, where the warped image depicts the object with the target pose. In some cases, the operations of this step refer to, or may be performed by, a warping model as described with reference to FIGS. 7, 9, 14, and 18. Warped image is an output image that depicts a transformed version of the subject image. For example, the warped image depicts the first object having the second pose. For example, when the subject image depicts a front view of a first face and the pose image depicts a second face looking at a direction, then the warped image depicts the first face looking at the same direction. In some cases, the warped image may capture the global feature (e.g., shape, color, texture, pose, etc.) of the subject image and the pose image.

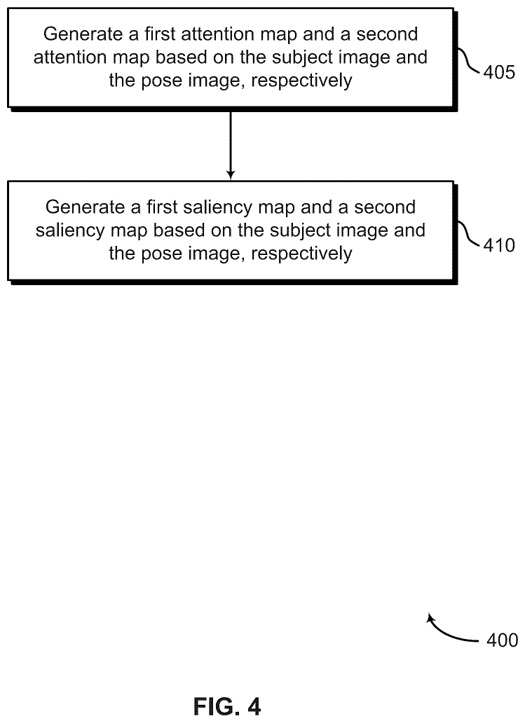

FIG. 4 shows an example of a method 400 for generating the keypoint information according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 405, the system generates a first attention map and a second attention map based on the subject image and the pose image, respectively. In some cases, the operations of this step refer to, or may be performed by, a keypoint detection model as described with reference to FIGS. 7, 8, and 18. An attention map may be a numerical representation of localized visual features in an image. The attention map encode key characteristics such as texture, shape, and structure from the subject image and the pose image. In some cases, the attention map may be generated from tokenized subject image and tokenized pose image. For example, if the input image has a dimension of 4×4, the keypoint detection model may generate 16 attention maps. Each of the attention map captures the detail of local visual features.

At operation 410, the system generates a first saliency map and a second saliency map based on the subject image and the pose image, respectively. In some cases, the operations of this step refer to, or may be performed by, a keypoint detection model as described with reference to FIGS. 7, 8, and 18. The saliency map is a representation that highlights an important or attention-grabbing region of an input image. The saliency map is used to identify regions that a model or human vision system would focus on. For example, if an image depicts a bear in a forest, the saliency map may be a black and white image highlighting the bear. In some cases, the saliency map is used to identify a foreground object and a background scene.

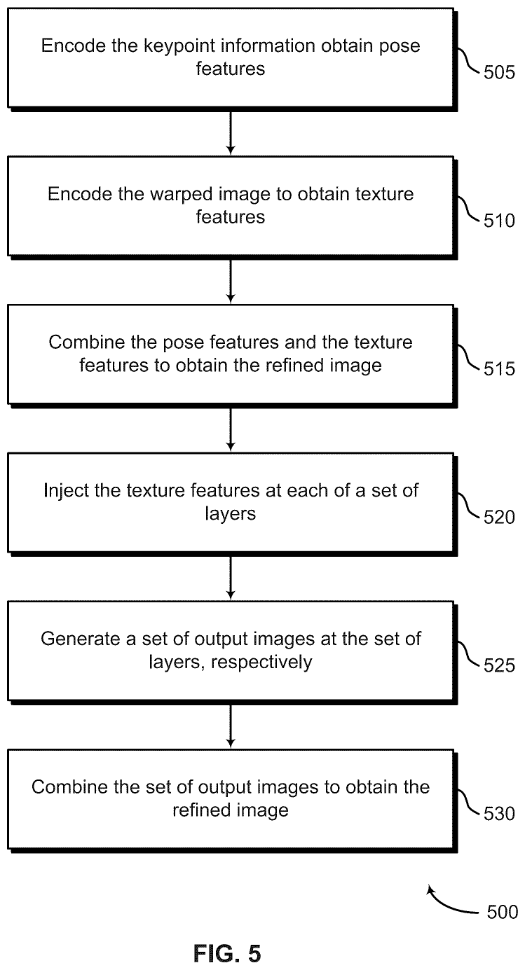

FIG. 5 shows an example of a method 500 for generating a refined image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 505, the system encodes the keypoint information obtain pose features. In some cases, the operations of this step refer to, or may be performed by, a pose encoder as described with reference to FIGS. 10 and 18. Features, such as texture feature and pose feature, are numerical representations generated by a computer model (e.g., an encoder) that represents information of an object depicted in the input images. For example, the information may include patterns, textures, shapes, and structures. In some cases, these features are represented in a high-dimensional vector that compresses the input data while preserving important information.

At operation 510, the system encodes the warped image to obtain texture features. In some cases, the operations of this step refer to, or may be performed by, a texture encoder as described with reference to FIGS. 10 and 18. In some cases, the texture features are numerical representations that represent information such as the patterns, textures, shapes, and structures of the warped image.

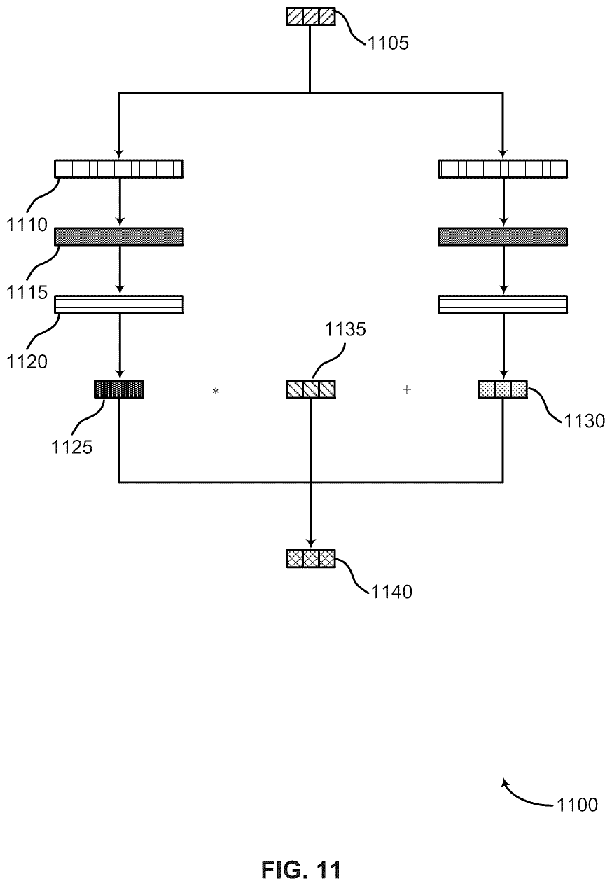

At operation 515, the system combines the pose features and the texture features to obtain the refined image. In some cases, the operations of this step refer to, or may be performed by, a texture injection block as described with reference to FIGS. 10, 11, and 18. In some cases, the texture injection block may generate scaling parameter and shifting parameter based on the texture features, and the scaling parameter and shifting parameter are combined with the pose feature to generate the combined feature. The combined feature is decoded to generate the refined image. Further detail on the texture injection block is described with reference to FIG. 11.

At operation 520, the system injects the texture features at each of a set of layers. In some cases, the operations of this step refer to, or may be performed by, an image generation model as described with reference to FIGS. 7, 10, 15, and 18. In some cases, the features generated at different layers of the encoder (or a U-Net structure) may include different types of information. For example, the low-level features generated at an early layer captures basic patterns like edges, corners, and textures. The mid-level features generated at an intermediate layer captures object parts, contours, and more complex features. The high-level features generated at deeper layers may capture semantic.

At operation 525, the system generates a set of output images at the set of layers, respectively. In some cases, the operations of this step refer to, or may be performed by, an image generation model as described with reference to FIGS. 7, 10, 15, and 18. For example, at each layer, the image generation model may include a corresponding decoding layer configured to generate an output based on the combined feature.

At operation 530, the system combines the set of output images to obtain the refined image. In some cases, the operations of this step refer to, or may be performed by, an image generation model as described with reference to FIGS. 7, 10, 15, and 18. In some cases, the image generation model includes a decoder configured to decode the combined feature to generate the output image (or the refined image). Further detail on the image generation model is described with reference to FIG. 10.

FIG. 6 shows an example of image-based pose transfer according to aspects of the present disclosure. The example shown includes image generation system 600, subject image 605, pose image 610, machine learning model 615, and synthetic image 620. In one embodiment, the image generation system 600 may be implemented in a user interface.

Referring to FIG. 6, the image generation system 600 generates the synthetic image 620 based on the subject image 605 and the pose image 610. For example, the subject image 605 and the pose image 610 are provided to the machine learning model 615. In one aspect, the machine learning model 615 includes a keypoint detection model, a warping model, and an image generation model. For example, the keypoint detection model is configured to generate keypoint information based on the subject image 605 and the pose image 610. The warping model is trained to generate a warped image based on the subject image 605, the pose image 610, and the keypoint information. The image generation model is trained to generate a refined image based on the keypoint information and the warped image. Further detail on the keypoint detection model, a warping model, and an image generation model is described in FIGS. 7-10.

Subject image 605 is an example of, or includes aspects of, the corresponding element described with reference to FIGS. 7-9, and 14. Pose image 610 is an example of, or includes aspects of, the corresponding element described with reference to FIGS. 7-9, and 14. Machine learning model 615 is an example of, or includes aspects of, the corresponding element described with reference to FIGS. 17 and 18.

### System Architecture

In FIGS. 7-12 and 17-19, an apparatus and system for image processing include a memory component, a processing device coupled to the memory component, the processing device configured to perform operations comprising, obtaining a subject image and a pose image, where the subject image depicts an object and the pose image depicts a target pose, obtaining keypoint information that associates a part of the subject image and a corresponding part of the pose image, generating, using a warping model, a flow map indicating a transformation of the part of the subject image by generating a plurality of flow map features at a plurality of different resolutions at different layers of the warping model, respectively, and generating a warped image based on the flow map and the subject image, where the warped image depicts the object with the target pose.

In some aspects, the warping model comprises a U-Net architecture. Some examples of the apparatus and system further include an image encoder configured to generate a first attention map and a second attention map based on the subject image and the pose image, respectively, where the keypoint information is based on the first attention map and the second attention map.

Some examples of the apparatus and system further include an image generation model configured to generate a refined image based on the keypoint information and the warped image. In some aspects, the image generation model comprises a U-Net architecture. In some aspects, the image generation model comprises a texture injection block configured to combine pose features and texture features.

FIG. 7 shows an example of a machine learning system 700 according to aspects of the present disclosure. The example shown includes machine learning system 700, subject image 705, pose image 710, keypoint detection model 715, keypoint information 720, warping model 725, warped image 730, image generation model 735, and refined image 740.

Referring to FIG. 7, the machine learning system 700 receives the subject image 705 and the pose image 710 to generate the refined image 740. For example, the keypoint detection model 715 receives the subject image 705 and the pose image 710 to generate the keypoint information 720. The keypoint detection model 715 extracts corresponding keypoints between the subject image 705 and the pose image 710 at the pixel-level. For example, the keypoint detection model 715 includes an image encoder configured to generate spatial feature descriptors (e.g., the subject attention map and the pose attention map) based on the subject image 705 and the pose image 710, respectively. The attention maps represent high-level patterns in the image and are used for matching keypoints. The keypoint detection model 715 further generates a subject saliency map based on the subject image 705, and a pose saliency map based on the pose image 710. The saliency map highlights the object depicted in the images. Then, the keypoint detection model 715 performs a keypoint detection process based on the subject attention map, the pose attention map, the subject saliency map, and the pose saliency map to generate the keypoint information. Further detail on the keypoint detection model 715 is described with reference to FIG. 8.

The warping model 725 receives subject image 705 and the pose image 710, and the keypoint information 720 to generate the warped image 730. For example, the warping model 725 transforms the subject image 705 to align with the target pose depicted in the pose image 710 by generating a flow map. In some embodiments, the warping model 725 includes a convolutional U-Net trained to generate a 2D flow map at each layer of the U-Net architecture. The flow map represents pixel transformation (e.g., a displacement of pixel points) between the subject image 705 and the pose image 710. In some embodiments, the final flow map is applied to the subject image to generate the warped image 730. In some cases, intermediate flow maps are upsampled and combined to generate the final flow map. By doing so, the warping model 725 ensures the generation of smooth transformation. Further detail on the warping model 725 is describe with reference to FIG. 9.

The image generation model 735 receives the keypoint information 720 and the warped image 730 to generate the refined image 740. The image generation model 735 refines the warped image 730 and generates the refined image 740 by enhancing textures, correcting occlusions, and preserving fine details. This is achieved using a pose encoder, a texture encoder, and a texture injection block. For example, the pose encoder generates pose features based on the keypoint information 720. The pose features include various information such as regions of the warped image to be corrected based on the pose structure. The text encoder generates texture features based on the warped image 730. The texture features capture fine-grained details such as color, texture, and pattern of the subject image 705. The texture injection block combines the pose texture and the texture feature to generate a combined feature at each layer. For example, the texture injection block generates a scaling parameter and a shifting parameter based on the texture feature, and these parameters are combined with the pose features. In some embodiments, the combined feature (or intermediate combined feature) is converted to an RGB image at different resolutions using a tRGB block. The residual connections and bilinear upsampling process are used to progressively refine the output image to generate the refined image 740. Further detail on the image generation model 735 is described with reference to FIG. 10. Further detail on the texture injection block is described with reference to FIG. 11.

Subject image 705 is an example of, or includes aspects of, the corresponding element described with reference to FIGS. 6, 8, 9, and 14. Pose image 710 is an example of, or includes aspects of, the corresponding element described with reference to FIGS. 6, 8, 9, and 14. Keypoint detection model 715 is an example of, or includes aspects of, the corresponding element described with reference to FIGS. 8 and 18. Keypoint information 720 is an example of, or includes aspects of, the corresponding element described with reference to FIGS. 8-10, 14, and 15.

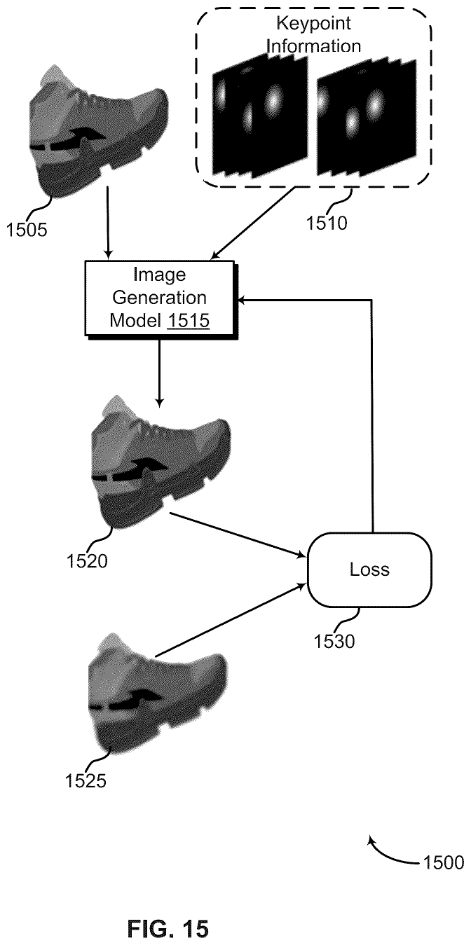

Warping model 725 is an example of, or includes aspects of, the corresponding element described with reference to FIGS. 9, 14, and 18. Warped image 730 is an example of, or includes aspects of, the corresponding element described with reference to FIGS. 9, 10, 14, and 15. Image generation model 735 is an example of, or includes aspects of, the corresponding element described with reference to FIGS. 10, 15, and 18. Refined image 740 is an example of, or includes aspects of, the corresponding element described with reference to FIGS. 10 and 15.

FIG. 8 shows an example of a keypoint detection model 800 according to aspects of the present disclosure. The example shown includes keypoint detection model 800, subject image 805, pose image 810, image encoder 815, patched subject attention map 820, subject saliency map 825, patched pose attention map 830, pose saliency map 835, keypoint detection process 840, and keypoint information 845. In one aspect, the keypoint detection model 800 includes an image encoder 815.

Referring to FIG. 8, the keypoint detection model 800 is configured to generate keypoint information 845 based on the subject image 805 and the pose image 810. In an embodiment, the image encoder 815 receives the subject image 805 and generates patched subject attention map 820 and a subject saliency map 825. In some cases, the image encoder 815 segments the subject image 805 into a plurality of patches (or image matches), where each of the plurality of patches represents a different region of the subject image 805. The patched subject attention map 820 represents high-level patterns in these patches.

Similarly, the image encoder 815 receives the pose image 810, and generates patched pose attention map 830 and a pose saliency map 835. In some cases, the image encoder 815 segments the pose image 810 into a plurality of patches (or image matches), where each of the plurality of patches represents a different region of the pose image 810. The patched pose attention map 830 represents high-level patterns in these patches. In some embodiments, the image encoder 815 used for the subject image 805 and the image encoder 815 used for the pose image 810 may be the same image encoder or different encoders.

According to some embodiments, the keypoint detection model 800 performs a keypoint detection process 840 based on the patched subject attention map 820, a subject saliency map 825, patched pose attention map 830, and a pose saliency map 835 to generate the keypoint information. For example, keypoint detection process 840 may include computing the similarity between the patched subject attention map 820 and the patched pose attention map 830. In one example, Best Buddies Pair (BBP) may be used to ensure the mutual nearest neighbor keypoint matching.

In an embodiment, the keypoint detection process 840 may further include keypoint selection and clustering. For example, k-means clustering is applied to a group of keypoints to reduce redundancy. In some embodiments, a predetermined number of top-ranked keypoints (e.g., 35) may be selected based on the saliency maps (e.g., the subject saliency map 825 and the pose saliency map 835). In some cases, the keypoint information 845 includes the subject keypoints and the pose keypoints that represent pose correspondence between the two images (e.g., the subject image 805 and the pose image 810).

According to some embodiments, the keypoint detection model 800 generates the keypoint information 845 based on the subject image 805 and the pose image 810. For example, the keypoint detection model 800 includes an image encoder 815. In some embodiments, for example, the image encoder 815 may be a pre-trained DINO-ViT model. In some embodiments, the image encoder is configured to extract spatial feature descriptors (Sₐ, Sₚ)∈

$${\text{?}}^{\frac{H}{8} \times \frac{w}{8} \times 768}$$

(e.g., the patched subject attention map 820 and patched pose attention map 830) corresponding to the two input images (lₐ, Iₚ)∈ [symbol] respectively. Additionally, the image encoder 815 generates the corresponding saliency maps (e.g., the subject saliency map 825 and the pose saliency map 835) based on the two input images (e.g., the subject image 805 and the pose image 810), respectively.

In some embodiments, the keypoint detection model 800 performs keypoint detection process 840 based on the patched subject attention map 820, subject saliency map 825, patched pose attention map 830, and the pose saliency map 835. In some examples, the keypoint detection process 840 may include computing cosine similarity between the patched subject attention map 820 and patched pose attention map 830 of the two input images. Then, feature matching is performed after the cosine similarity to generate matching correspondence between the objects from the two input images. For example, the feature matching may include applying the Best Buddies Pair (BBP). In some cases, the feature matching is performed on non-background patches based on the saliency map values. For example, saliency map values that indicates zero(s) represent that the region of the image is a background. Accordingly, the mutually nearest neighbor descriptor pairs can be obtained. According to some embodiments, a pair of descriptors sₐ∈Sₐ and sₚ∈Sₚ are considered as best-buddy pair when

$$N N ( {s}_{a} , {S}_{p} ) = {s}_{p} and NN ( {s}_{p} , {S}_{a} ) = {s}_{a} \qquad ( 1 )$$

where NN(sₐ,Sₚ) represents the nearest neighbor of sₐ in the set Sₚ under cosine similarity.

In some embodiments, the keypoint detection model 800 performs k-means clustering to the patch descriptors after concatenation of the patch descriptors. In some cases, a predetermined number of points determines the number of clusters. Additionally, the patches are ranked based on the values in the salience maps, and the top-k points are selected for further process. In some cases, for example, k is set to 35 points. These points are represented as Pₐ∈ [symbol] (e.g., pose correspondence for the subject image 805) and Pₚ∈ [symbol] (e.g., pose correspondence for the pose image 810). In some cases, the keypoint information 845 includes these points.

Keypoint detection model 800 is an example of, or includes aspects of, the corresponding element described with reference to FIGS. 7 and 18. Subject image 805 is an example of, or includes aspects of, the corresponding element described with reference to FIGS. 6, 7, 9, and 14. Pose image 810 is an example of, or includes aspects of, the corresponding element described with reference to FIGS. 6, 7, 9, and 14.

Image encoder 815 is an example of, or includes aspects of, the corresponding element described with reference to FIG. 18. Keypoint information 845 is an example of, or includes aspects of, the corresponding element described with reference to FIGS. 7, 9, 10, 14, and 15.

FIG. 9 shows an example of a warping model 900 according to aspects of the present disclosure. The example shown includes warping model 900, subject image 905, pose image 910, keypoint information 915, convolutional U-Net 930, flow pyramid 935, flow map 940, warping process 945, and warped image 950. In one aspect, keypoint information 915 includes subject keypoint 920 and pose keypoint 925. In one aspect, the warping model 900 includes a convolutional U-Net 930.

Referring to FIG. 9, the warping model 900 is trained to generate warped image 950 based on the subject image 905, the pose image 910, and the keypoint information 915. For example, the convolutional U-Net receives the subject image 905, the pose image 910, and the keypoint information 915 (which includes the subject keypoint 920 and pose keypoint 925) to generate flow pyramid 935. At each layer of the convolutional U-Net 930, the convolutional U-Net 930 generates a flow map having a layer-specific resolution. Each of the flow maps represents pixel transformation (or displacement) from the subject image 905 to the pose image 910. In some cases, the flow pyramid 935 includes n hierarchical flow maps, where each higher-level flow map refines the lower-level flow maps.

In some cases, each flow map in the flow pyramid 935 is upscaled to the same final dimension (or resolution) to generate the flow map 940. In an embodiment, the final flow map is used to warp the subject image 905 using the warping process 945 to generate warped image 950. During the warping process 945, the pixels of the subject image 905 are mapped to the new positions based on the final flow map. In some cases, regions without no valid pixel mapping may include an occlusion region, and the occlusion region can be refined using the image generation model described with reference to FIG. 10. For example, the warped image 950 depicts the object from the subject image 905 having a target pose depicted in the pose image 910.

According to some embodiments, the warping model 900 is trained to transform the appearance image Iₐ (e.g., the subject image 905) to align with the pose depicted in the pose image Iₚ (e.g., the pose image 910) using a skip U-Net architecture (e.g., convolutional U-Net 930) that generates per-pixel warp parameters. According to some embodiment, the warping model 900 generates a 76-channel input for the U-Net by stacking the points along with the respective images. The input includes subject image 905 (3 channels), the subject keypoint 920 (35 channels), the pose image 910 (3 channels), and the pose keypoint 925 (35 channels).

Then, these inputs are provided to the convolutional U-Net 930 with twelve layers that process the input of dimensions (76,H,W), and generating K candidate flow maps (fₗ for l∈0, . . . , K−1), where each map fₗ is twice the size of the preceding map fₗ₋₁ and fₖ₋₁∈ [symbol] . In an embodiment, these individual flow maps are interpolated to a uniform size, and a pyramid of k maps with varying structural details are generated. In some cases, the flow maps may undergo convex upsampling, which is a generalization of bilinear upsampling that learns the upsampling kernel from the last U-Net layer and the given flow map. In some cases, the upsampling method enhances the map by preserving the smoothness and continuity of vectors, reducing artifacts, and retaining finer details. Then, the warping model 900 predicts the per-pixel appearance flow, and generates the transformation of the appearance image. As a result, the warping model 900 can generate a more accurate and realistic flow estimation, which effectively warps the subject image 905 to align with the target pose depicted in the pose image 910.

According to some embodiments, the output flow map fₖ₋₁ (e.g., the final flow map 940) is used to warp the appearance image Iₐ (e.g., the subject image 905) to obtain the warped image I_{wrp} (e.g., warped image 950). In some embodiments, the intermediate flow maps fₗ for l∈{0, . . . , K−2} are also used to generate intermediate warped images

$$( {I}_{wrp}^{l} ) .$$

In some cases, the final output flow map and the intermediate flow maps may be combined to generate the flow map 940. The final flow map is applied to the subject image 905 using the warping process 945 to generate the warped image 950.

Warping model 900 is an example of, or includes aspects of, the corresponding element described with reference to FIGS. 7, 14, and 18. Subject image 905 is an example of, or includes aspects of, the corresponding element described with reference to FIGS. 6-8, and 14. Pose image 910 is an example of, or includes aspects of, the corresponding element described with reference to FIGS. 6-8, and 14.

Keypoint information 915 is an example of, or includes aspects of, the corresponding element described with reference to FIGS. 7, 8, 10, 14, and 15. Convolutional U-Net 930 is an example of, or includes aspects of, the corresponding element described with reference to FIG. 18. Warped image 950 is an example of, or includes aspects of, the corresponding element described with reference to FIGS. 7, 10, 14, and 15.

FIG. 10 shows an example of an image generation model 1000 according to aspects of the present disclosure. The example shown includes image generation model 1000, keypoint information 1005, pose encoder 1010, pose feature 1015, warped image 1020, texture encoder 1025, texture feature 1030, texture injection block 1035, combined feature 1040, image decoder 1045, and refined image 1050. In one aspect, the image generation model 1000 includes a pose encoder 1010, a texture encoder 1025, a texture injection block 1035, and an image decoder 1045.

Referring to FIG. 10, the image generation model 1000 receives the keypoint information 1005 and the warped image 1020 to generate the refined image 1050. For example, the pose encoder 1010 is trained to generate pose feature 1015 based on the keypoint information 1005. In some cases, the pose feature 1015 represents transformation information based on the two poses depicted in the subject image and the pose image. The texture encoder 1025 is trained to generate texture feature 1030 based on the warped image 1020. For example, the texture feature 1030 captures the fine-grained details such as the color, material, and texture of the warped image 1020. In some cases, the fine-grained details of the warped image 1020 may be substantially the same as the subject image.

In an embodiment, the texture injection block 1035 combines the pose feature 1015 and the texture feature 1030 at the lowest layer to generate the combined feature 1040. In some cases, the combined feature 1040 at this layer represents the texture infusion into the pose representation at the sematic level. In an embodiment, an image decoder (e.g., a tRGB block) may be used to generate an intermediate output image based on the combined feature 1040. The intermediate output image may be upscaled to a resolution consistent with the resolution of the next layer.

Then, the pose feature 1015 and the texture feature 1030 at the next higher layer (having a higher resolution than the previous layer) are combined to generate a subsequent combined feature. A tRGB block may be used to generate a subsequent output image based on the subsequent combined feature. The subsequent output image and the intermediate output image may be combined. In some embodiments, the image decoder 1045 (e.g., a tRGB block) generates the refined image 1050 based on the combined feature 1040. In some cases, the intermediate output image and the subsequent output image are combined to generate the refined image 1050.

According to some embodiments, the image generation model 1000 generates a refined image 1050 based on the keypoint information 1005 and the warped image 1020. For example, the image generation model takes the pose correspondence Pₚ, appearance correspondence Pₐ, and the final warped image I_{wrp} (e.g., warped image 1020) as inputs. In some cases, the keypoint information 1005 includes the pose correspondence Pₚ and appearance correspondence Pₐ. In some cases, the intermediate warped images might not be used as an input.

In some aspects, the image generation model 1000 includes a pose encoder PoseEnc (e.g., pose encoder 1010) trained to takes the keypoint information 1005 to generate pose feature 1015. In some cases, for example, the pose encoder 1010 includes a ResNet architecture. In some cases, for example, the pose encoder includes a U-Net architecture. By using the pose and appearance correspondence as inputs, the pose encoder can distinguish between the parts of the target image (e.g., the refined image 1050) where the corresponding texture can be obtained from the source image (e.g., the subject image), and thus reduces hallucination. In some cases, the pose encoder is trained to identify and correlate the relationship between these two poses:

$${e}_{p} = PoseEn c ( {P}_{a} , {P}_{p} ) \qquad ( 2 )$$

According to some embodiments, the image generation model 1000 includes a texture encoder 1025 trained to takes the warped image 1020 to generate texture feature 1030. In some cases, for example, the texture encoder 1025 includes a ResNet architecture. In some cases, for example, the texture encoder 1025 includes a U-Net architecture. In some cases, the texture encoder 1025 generates texture encodings at various hierarchical scales. For example, the low-resolution features effectively capture the semantic and style of the object depicted in the warped image, and the high-resolution features capture the fine-grained details from the source image. Additionally, skip connections in the texture encoder is used to merge low-resolution features and high-resolution features, thereby capturing multiple levels of semantics.

According to some embodiments, the image generation model 1000 includes a texture injection block 1035 configured to combine the pose feature 1015 and the texture feature 1030 at each corresponding layers. For example, at each layer, the texture information is combined with the pose encodings at various scales through 2D modulation. The texture injection block 1035 includes two sequential 1×1 convolutional layers separated by a ReLU activation function (e.g., shown in FIG. 11). The texture encoding (e.g., texture feature 1030) is passed though the texture injection block 1035 to generate the scaling a and shifting β parameters. Then the scaling a and shifting β parameters are used to perform spatially varying modulation of the pose encodings eₚ as follows:

$${e}_{infused}^{i} = α * {e}_{p}^{i} + β \qquad ( 3 )$$

The features

$${e}_{infused}^{i}$$

(e.g., the combined feature 1040) are normalized to zero mean and unit variance, and noise may be added using the broadcast operation B to obtain

$${e}_{out}^{i} .$$

For example, this operation generates a stochastic variation and enables the generator to synthesize more realistic images.

$${e}_{out}^{i} = B ( {e}_{infused}^{i} ) \qquad ( 4 )$$

According to an embodiment, each

$${e}_{out}^{i}$$

obtained from the texture injection block is further processed using a tRGB block. The tRGB block may be a 1×1 convolution layer with 3 output channels, generating the final image at a specific resolution. Then, the output is added using residual connections post bilinear upsampling to the size of the next block. Then, the combined feature 1040 is provided to an image decoder 1045 to generate the refined image 1050.

Image generation model 1000 is an example of, or includes aspects of, the corresponding element described with reference to FIGS. 7, 15, and 18. Keypoint information 1005 is an example of, or includes aspects of, the corresponding element described with reference to FIGS. 7-9, 14, and 15. Pose encoder 1010 is an example of, or includes aspects of, the corresponding element described with reference to FIG. 18.

Pose feature 1015 is an example of, or includes aspects of, the corresponding element described with reference to FIG. 11. Warped image 1020 is an example of, or includes aspects of, the corresponding element described with reference to FIGS. 7, 9, 14, and 15. Texture encoder 1025 is an example of, or includes aspects of, the corresponding element described with reference to FIG. 18.

Texture feature 1030 is an example of, or includes aspects of, the corresponding element described with reference to FIG. 11. Texture injection block 1035 is an example of, or includes aspects of, the corresponding element described with reference to FIGS. 11 and 18. Combined feature 1040 is an example of, or includes aspects of, the corresponding element described with reference to FIG. 11. Refined image 1050 is an example of, or includes aspects of, the corresponding element described with reference to FIGS. 7 and 15.

FIG. 11 shows an example of a texture injection block 1100 according to aspects of the present disclosure. The example shown includes texture injection block 1100, texture feature 1105, first convolutional layer 1110, ReLu activation function 1115, second convolutional layer 1120, scaling parameter 1125, shifting parameter 1130, pose feature 1135, and combined feature 1140.

Referring to FIG. 11, texture injection block 1100 is configured to generate combined feature 1140 based on the texture feature and the pose feature 1135. The texture injection block 1100 integrates texture details from the warped image into the pose feature 1135. As a result, the refined image may have realistic textures, fine-grained details, and structural integrity. In an embodiment, the texture feature 1105 is passed through the first convolutional layer 1110, a ReLu activation function 1115, and a second convolutional layer 1120 to generate the scaling parameter 1125 (e.g., scaling parameter α described with reference to FIG. 10). In an embodiment, the texture feature 1105 is passed through the first convolutional layer 1110, a ReLu activation function 1115, and a second convolutional layer 1120 to generate the shifting parameter 1130 (e.g., the shifting parameter β described with reference to FIG. 10). Then, the scaling parameter 1125 and the shifting parameter 1130 are combined with the pose feature 1135 to generate the combined feature 1140.

Texture injection block 1100 is an example of, or includes aspects of, the corresponding element described with reference to FIGS. 10 and 18. Texture feature 1105 is an example of, or includes aspects of, the corresponding element described with reference to FIG. 10. Pose feature 1135 is an example of, or includes aspects of, the corresponding element described with reference to FIG. 10. Combined feature 1140 is an example of, or includes aspects of, the corresponding element described with reference to FIG. 10.

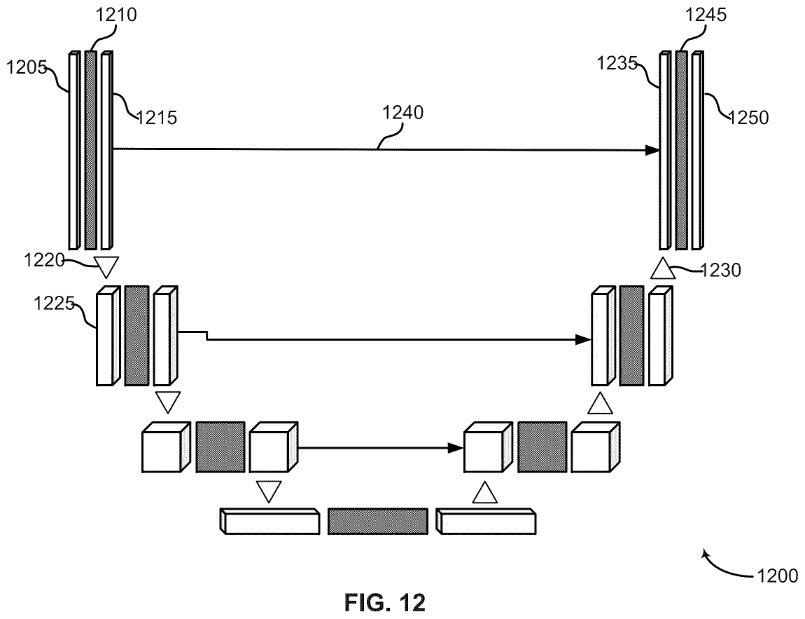

FIG. 12 shows an example of a U-Net 1200 architecture according to aspects of the present disclosure. The example shown includes U-Net 1200, input feature 1205, initial neural network layer 1210, intermediate feature 1215, down-sampling layer 1220, down-sampled feature 1225, up-sampling process 1230, up-sampled feature 1235, skip connection 1240, final neural network layer 1245, and output feature 1250.

Referring to FIG. 12, the pose encoder and the texture encoder described with reference to FIG. 10 are examples of, or include aspects of, the U-Net 1200. In some examples, U-Net 1200 is a type of convolutional neural network (CNN) architecture used to process data using a skip connection. In some aspects, U-Net 1200 includes an encoder-decoder structure. For example, the encoder portion of the U-Net 1200 extracts features from an input (e.g., an image) in a low-level features in a high resolution (e.g., an input having a resolution of 256×256×3) and gradually extracts higher-level features in lower resolutions. At the bottleneck layer (e.g., the lowest CNN layer that has a resolution of 16×16×1024), the highest-level feature (such as abstract patterns, object structures) may be extracted.

Then, the decoding portion of the U-Net 1200 decodes the encoded features gradually from the lowest layer to the highest layer to generate an output feature (or an output image). In some aspects, the decoding layers perform upsampling and convolution to reconstruct the input data (e.g., an image) while preserving spatial details. In some cases, skip connection is used to directly passed the features from the encoding layers to the corresponding decoding layers, ensuring the preservation of fine-grained details of the input.

In one aspect, the U-Net 1200 takes input feature 1205 having an initial resolution and an initial number of channels and processes the input feature 1205 using an initial neural network layer 1210 (e.g., a convolutional network layer) to produce intermediate feature 1215. The intermediate feature 1215 is then down-sampled using a down-sampling layer 1220 such that the down-sampled feature 1225 has a resolution less than the initial resolution and a number of channels greater than the initial number of channels.

This process is repeated multiple times, and then the process is reversed. For example, the down-sampled feature 1225 is up-sampled using up-sampling process 1230 to obtain up-sampled feature 1235. The up-sampled feature 1235 can be combined with intermediate feature 1215 having the same resolution and number of channels via a skip connection 1240. These inputs are processed using a final neural network layer 1245 to produce output feature 1250. In some cases, the output feature 1250 has the same resolution as the initial resolution and the same number of channels as the initial number of channels.

In some cases, U-Net 1200 takes an additional input feature to produce conditionally generated output. For example, the additional input feature could include a vector representation of a reference image (or features of the pose image). The additional input feature can be combined with the intermediate feature 1215 within the neural network at one or more layers. For example, a cross-attention module can be used to combine the additional input features and the intermediate feature 1215.

### Training and Evaluation

In FIGS. 13-16, a method, apparatus, non-transitory computer readable medium, and system for training the machine learning model includes obtaining a training set including a training subject image depicting a first object in a first pose, a training pose image depicting a second object in a second pose, and a ground-truth image depicting the first object in the second pose, training, using the training set, a warping model to generate a warped image based on the training subject image and the training pose image, computing a warping loss based on the warped image and the ground-truth image, and training the warping model based on the warping loss.

Some example of the method, apparatus, non-transitory computer readable medium, and system further include obtaining 3D dataset of the first object and the second object, wherein the training subject image and the training pose image are obtained based on the 3D dataset.

Some example of the method, apparatus, non-transitory computer readable medium, and system further include generating keypoint information based on the training subject image and the training pose image, generating, using an image generation model, a refined image based on the warped image and the keypoint information, generating a loss based on the refined image and the ground-truth image, and training the image generation model based on the loss.

FIG. 13 shows an example of training dataset preparation according to aspects of the present disclosure. The example shown includes first 3D model 1300, second 3D model 1305, pose orientations 1310, training subject image 1315, training pose image 1320, and ground-truth image 1325.

Referring to FIG. 13, the system generates training dataset (including the training pose image 1320) based on a set of 3D models (e.g., the first 3D model 1300, second 3D model 1305). For example, by applying the pose orientations 1310 to the first 3D model 1300, the training subject image 1315 can be obtained. Similarly, by applying the pose orientations 1310 to the second 3D model 1305, the training pose image 1320 can be obtained. In some cases, a plurality of combinations using the training subject image 1315 and the training pose image 1320 is performed to obtain the ground-truth image 1325.

According to some embodiments, 3D models (e.g., the first 3D model 1300, second 3D model 1305) from, for example, Objaverse were used, ensuring a diverse collection of objects with varying shapes and structures. To generate pose variations, each 3D model was rendered into 2D images by applying random Euler rotations (e.g., pose orientations 1310) (ranging from 30° to 180°) along different axes. This resulted in multiple views of the same object in different poses. Additionally, to improve generalization, two types of image pairings were created. First, the same object in different poses to ensure intra-instance consistency. Second, different objects of the same category in similar poses increasing category-level generalization.

To enhance training robustness, data augmentation techniques were applied, including random cropping, color jittering, Gaussian noise, flipping, and rotation, helping the model handle real-world variations. The dataset was filtered to exclude multi-mesh objects, ensuring that only clean, single-mesh models were used. This structured dataset enables the machine learning model to learn precise pose transformations while preserving fine-grained details such as textures, logos, and colors. By training on a large number of pose-aligned pairs, the machine learning model effectively learned to warp objects into new poses while retaining their identity and structural coherence.

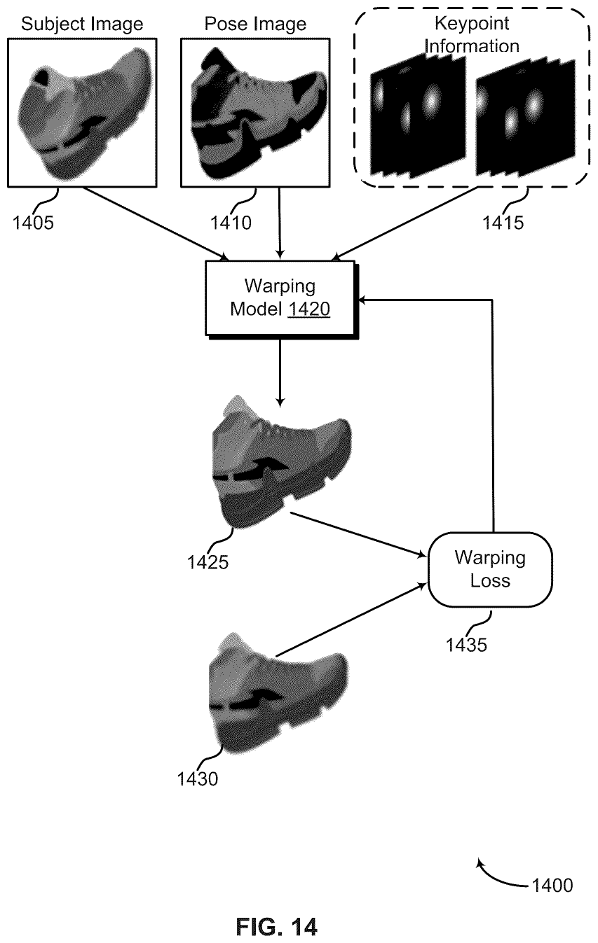

FIG. 14 shows an example of training a warping model 1420 according to aspects of the present disclosure. The example shown includes training system 1400, subject image 1405, pose image 1410, keypoint information 1415, warping model 1420, warped image 1425, ground-truth image 1430, and warping loss 1435.

Referring to FIG. 14, the training system 1400 trains the warping model 1420 using the warping loss. For example, the warping model 1420 generates warped image 1425 based on the subject image 1405, pose image 1410, and keypoint information 1415. Details regarding the generation of warped image are described with reference to FIG. 9. In an embodiment, a training component (e.g., the training component described with reference to FIG. 17) computes a warping loss 1435 based on the warped image 1425 and the ground-truth image 1430. Then, the training component updates parameters of the warping model 1420 based on the warping loss 1435.

According to some embodiments, the training system 1400 may apply a various losses to each warped image. For example, the warping loss 1435 include a L1 loss (L₁), perceptual similarity loss (Lₚₑᵣ), and a style loss (L_{sty}). In some cases, these losses are used at intermediate layers to regularize the flow module, enabling the network to learn both global and fine-grained warping details. In some cases, the flow maps are further fine-tuned based on a total variation loss (Lₜᵥ(fₗ)) and an initial TPS-based loss (L_{flow}) to ensure smooth transitions and faster convergence. In some cases, these losses are combined to generate the warping loss L_{wrp} (e.g., the warping loss described with reference to FIG. 14). The warping loss L_{wrp} can be computed as:

$${L}_{w r p} = {\sum }_{l = 0}^{l = K - 1} {L}_{w} ( {L}_{wrp}^{l} , {f}_{l} ) \qquad ( 5 )$$

$$for ,$$

$${L}_{w} ( I , f ) = {β}_{1} {‖ I , {I}_{m}^{gt} ‖}_{1} + {β}_{2} {L}_{p e r} ( I , {I}_{m}^{gt} ) + {β}_{3} {L}_{sty} ( I , {I}_{m}^{gt} ) + {β}_{4} {L}_{flow} ( f , {f}_{tps} ) + {β}_{5} {L}_{tv} ( f ) \qquad ( 6 )$$

Training system 1400 is an example of, or includes aspects of, the corresponding element described with reference to FIG. 15. Subject image 1405 is an example of, or includes aspects of, the corresponding element described with reference to FIGS. 6-9. Pose image 1410 is an example of, or includes aspects of, the corresponding element described with reference to FIGS. 6-9.

Keypoint information 1415 is an example of, or includes aspects of, the corresponding element described with reference to FIGS. 7-10, and 15. Warping model 1420 is an example of, or includes aspects of, the corresponding element described with reference to FIGS. 7, 9, and 18. Warped image 1425 is an example of, or includes aspects of, the corresponding element described with reference to FIGS. 7, 9, 10, and 15. Ground-truth image 1430 is an example of, or includes aspects of, the corresponding element described with reference to FIG. 15.

FIG. 15 shows an example of training an image generation model according to aspects of the present disclosure. The example shown includes training system 1500, warped image 1505, keypoint information 1510, image generation model 1515, refined image 1520, ground-truth image 1525, and loss 1530.

Referring to FIG. 15, the training system 1500 trains the image generation model 1515 using the loss 1530. For example, the image generation model 1515 generates refined image 1520 based on the warped image 1505 and keypoint information 1510. Details regarding the generation of refined image are described with reference to FIG. 10. In an embodiment, a training component (e.g., the training component described with reference to FIG. 17) computes a loss 1530 based on the refined image 1520 and the ground-truth image 1525. Then, the training component updates parameters of the image generation model 1515 based on the loss 1530.

According to some embodiments, the image generation model 1515 may be trained using a loss 1530. For example, the loss 1530 includes L1, perceptual, style, and LSGAN losses based on the output image Iₒᵤₜ (e.g., refined image 1520) and ground-truth image I_{gt} (e.g., ground-truth image 1525). For example, the L1 loss preserves pixel-level identity and texture. The perceptual loss and the style loss ensure high-level semantic alignment. LSGAN loss applied with target pose Pₚ, improves pose alignment and enhances sharpness by reducing artifacts. Accordingly, the loss 1530 can be computed as:

$${L}_{g e n} = {α}_{l 1} {‖ {I}_{out} , {I}_{gt} ‖}_{1} + {α}_{per} {L}_{per} ( {I}_{out} , {I}_{gt} ) + {α}_{sty} {L}_{sty} ( {I}_{out} , {I}_{gt} ) + {α}_{adv} {L}_{adv} ( {I}_{out} , {I}_{gt} , {P}_{p} ) \qquad ( 7 )$$

Training system 1500 is an example of, or includes aspects of, the corresponding element described with reference to FIG. 14. Warped image 1505 is an example of, or includes aspects of, the corresponding element described with reference to FIGS. 7, 9, 10, and 14. Keypoint information 1510 is an example of, or includes aspects of, the corresponding element described with reference to FIGS. 7-10, and 14.

Image generation model 1515 is an example of, or includes aspects of, the corresponding element described with reference to FIGS. 7, 10, and 18. Refined image 1520 is an example of, or includes aspects of, the corresponding element described with reference to FIGS. 7 and 10. Ground-truth image 1525 is an example of, or includes aspects of, the corresponding element described with reference to FIG. 14.

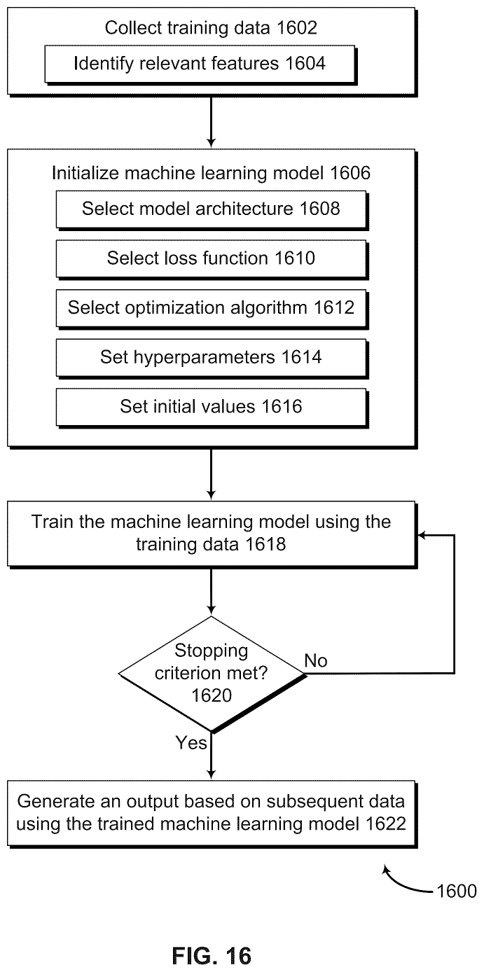

FIG. 16 shows an example of a flow diagram depicting an algorithm as a step-by-step procedure in an example implementation of operations performable for training a machine learning model according to aspects of the present disclosure. In some embodiments, the procedure 1600 describes an operation of the training component described for training the machine learning model 1805 as described with reference to FIG. 18. The procedure 1600 provides one or more examples of generating training data, use of the training data to train a machine-learning model, and use of the trained machine-learning model to perform a task

To begin in this example, a machine-learning system collects training data (block 1602) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1604) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1606). Initialization of the machine-learning model includes selecting a model architecture (block 1608) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1610). The loss function is utilized to measure a difference between an output of the machine-learning model (e.g., the model predictions) and target values (e.g., as expressed by the training data) to be used to train the machine-learning model. Additionally, an optimization algorithm is selected (block 1612) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1616) examples of which include initializing weights and biases of nodes to increase efficiency in training and computational resources consumption as part of training. Hyperparameters are also set (block 1614) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1618) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1620), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1620), procedure 1600 continues the training of the machine-learning model using the training data (block 1618) in this example.

If the stopping criterion is met (“yes” from decision block 1620), the trained machine-learning model is then utilized to generate an output based on subsequent data (block 1622). The trained machine-learning model, for instance, is trained to perform a task as described above and therefore, once trained is configured to perform that task based on subsequent data received as an input and processed by the machine-learning model.

### System Apparatus

FIG. 17 shows an example of an image processing apparatus 1700 according to aspects of the present disclosure. The example shown includes image processing apparatus 1700, processor unit 1705, I/O module 1710, memory unit 1715, and training component 1725. In one aspect, memory unit 1715 includes machine learning model 1720.

According to some embodiments of the present disclosure, image processing apparatus 1700 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 1700 is an example of, or includes aspects of, the corresponding element described with reference to FIGS. 1 and 18.

Processor unit 1705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 1705 is configured to operate a memory array using a memory controller. In other cases, a memory controller is integrated into the processor. In some cases, processor unit 1705 is configured to execute computer-readable instructions stored in a memory to perform various functions. In some embodiments, processor unit 1705 includes special-purpose components for modem processing, baseband processing, digital signal processing, or transmission processing. Processor unit 1705 is an example of, or includes aspects of, the processor described with reference to FIG. 19.

I/O module 1710 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 1710 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 1710 is an example of, or includes aspects of, the I/O interface described with reference to FIG. 19.

Examples of memory unit 1715 include random access memory (RAM), read-only memory (ROM), or a hard disk. Examples of memory unit 1715 include solid-state memory and a hard disk drive. In some examples, memory unit 1715 is used to store computer-readable, computer-executable software including instructions that, when executed, cause a processor to perform various functions described herein.

In some cases, memory unit 1715 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 1715 store information in the form of a logical state.

In one aspect, memory unit 1715 includes machine learning model 1720. Further detail in the machine learning model 1720 is described with reference to FIG. 18. Memory unit 1715 is an example of, or includes aspects of, the memory subsystem described with reference to FIG. 19. Machine learning model 1720 is an example of, or includes aspects of, the corresponding element described with reference to FIGS. 6 and 18.

According to some aspects, image processing apparatus 1700 includes a training component 1725. The training component 1725 is implemented as software stored in memory unit 1715 and executable by processor unit 1705, as firmware, as one or more hardware circuits, or as a combination thereof. According to some embodiments, the training component 1725 is implemented as software stored in a memory unit and executable by a processor in the processor unit of a separate computing device, as firmware in the separate computing device, as one or more hardware circuits of the separate computing device, or as a combination thereof. In some examples, the training component 1725 is part of another apparatus other than image processing apparatus 1700 and communicates with the image processing apparatus 1700. In some examples, training component 1725 is part of image processing apparatus 1700.

In some aspects, the training component 1725 trains the machine learning model 1720. According to some embodiments, the training component 1725 obtains a training set including a training subject image depicting a first object in a first pose, a training pose image depicting a second object in a second pose, and a ground-truth image depicting the first object in the second pose. In some examples, the training component 1725 trains, using the training set, a warping model to generate a warped image based on the training subject image and the training pose image. In some examples, the training component 1725 computes a warping loss based on the warped image and the ground-truth image. In some example, the training component 1725 trains the warping model based on the warping loss.

FIG. 18 shows an example of the machine learning model 1805 of the image processing apparatus 1800 according to aspects of the present disclosure. The example shown includes image processing apparatus 1800 and machine learning model 1805. In one aspect, machine learning model 1805 includes image encoder 1810, keypoint detection model 1815, warping model 1820, and image generation model 1830. In one aspect, warping model 1820 includes convolutional U-Net 1825. In one aspect, image generation model 1830 includes pose encoder 1835, texture encoder 1840, and texture injection block 1845. Image processing apparatus 1800 is an example of, or includes aspects of, the corresponding element described with reference to FIGS. 1 and 17.

In some cases, a machine learning model 1805 is a computational algorithm, model, or system designed to recognize patterns, make predictions, or perform a specific task (for example, image processing) without being explicitly programmed. According to some aspects, the machine learning model 1805 is implemented as software stored in memory unit 1715 in FIG. 17 and executable by processor unit 1705 in FIG. 17, as firmware, as one or more hardware circuits, or as a combination thereof.

According to some embodiments of the present disclosure, the machine learning model 1805 includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of its inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, the machine learning model 1805 includes a computer-implemented convolutional neural network (CNN). CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model 1805 includes machine learning parameters. Machine learning parameters, also known as model parameters or weights, are variables that provide behaviors and characteristics of the machine learning model 1805. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that allow the machine learning model 1805 to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, the machine learning model 1805 includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, the machine learning model 1805 includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of its elements) is added to the embedded representation (n-dimensional vector) of each word. In some examples, a transformer network includes an attention mechanism, where the attention looks at an input sequence and decides at each step which other parts of the sequence are important.

The attention mechanism involves a query, keys, and values denoted by Q, K, and V, respectively. Q is a matrix that contains the query (vector representation of one word in the sequence), K are the keys (vector representations of the words in the sequence), and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, which allows an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering the relevance of each input element with respect to the current state of the ANN.

The term “self-attention” refers to a machine learning model 1805 in which representations of the input interact with each other to determine attention weights for the input. Self-attention can be distinguished from other attention models because the attention weights are determined at least in part by the input itself. Machine learning model 1805 is an example of, or includes aspects of, the corresponding element described with reference to FIGS. 6 and 17.

According to some aspects, image encoder 1810 is implemented as software stored in memory unit 1715 in FIG. 17 and executable by processor unit 1705 in FIG. 17, as firmware, as one or more hardware circuits, or as a combination thereof. According to some aspects, image encoder 1810 is configured to generate a first attention map and a second attention map based on the subject image and the pose image, respectively, where the keypoint information is based on the first attention map and the second attention map. Image encoder 1810 is an example of, or includes aspects of, the corresponding element described with reference to FIG. 8.

According to some aspects, keypoint detection model 1815 is implemented as software stored in memory unit 1715 in FIG. 17 and executable by processor unit 1705 in FIG. 17, as firmware, as one or more hardware circuits, or as a combination thereof. According to some aspects, keypoint detection model 1815 generates a first attention map and a second attention map based on the subject image and the pose image, respectively, where the keypoint information is based on the first attention map and the second attention map. In some examples, keypoint detection model 1815 generates a first saliency map and a second saliency map based on the subject image and the pose image, respectively, where the keypoint information is based on the first saliency map and the second saliency map.

According to some aspects, keypoint detection model 1815 obtains a subject image and a pose image, where the subject image depicts an object and the pose image depicts a target pose. In some examples, keypoint detection model 1815 extracts keypoint information from the subject image and the pose image, where the keypoint information associates a part of the subject image and a corresponding part of the pose image.

In some examples, keypoint detection model 1815 generates a first attention map and a second attention map based on the subject image and the pose image, respectively, where the keypoint information is based on the first attention map and the second attention map. In some examples, keypoint detection model 1815 generates a first saliency map and a second saliency map based on the subject image and the pose image, respectively, where the keypoint information is based on the first saliency map and the second saliency map. Keypoint detection model 1815 is an example of, or includes aspects of, the corresponding element described with reference to FIGS. 7 and 8.

According to some aspects, warping model 1820 is implemented as software stored in memory unit 1715 in FIG. 17 and executable by processor unit 1705 in FIG. 17, as firmware, as one or more hardware circuits, or as a combination thereof. According to some aspects, warping model 1820 obtains a subject image and a pose image, where the subject image depicts an object and the pose image depicts a target pose. In some examples, warping model 1820 obtains keypoint information that associates a part of the subject image and a corresponding part of the pose image. In some examples, warping model 1820 generates a flow map indicating a transformation of the part of the subject image by generating a set of flow map features at a set of different resolutions at different layers of the warping model 1820, respectively. In some examples, warping model 1820 generates a warped image based on the flow map and the subject image, where the warped image depicts the object with the target pose. In some aspects, the warping model 1820 is trained using a warping loss that includes a set of terms corresponding to the different layers of the warping model 1820, respectively.

According to some aspects, warping model 1820 generates a warped image based on the subject image, the pose image, and the keypoint information, where the warped image depicts the object with the target pose. In some examples, warping model 1820 generates a flow map indicating a transformation of the part of the subject image by generating a set of flow map features at a set of different resolutions at different layers of the warping model 1820, respectively. In some aspects, the warping model 1820 is trained using a warping loss that includes a set of terms corresponding to a different layers of the warping model 1820, respectively.

In some aspects, the warping model 1820 includes a U-Net architecture. In one aspect, warping model 1820 includes convolutional U-Net 1825. Warping model 1820 is an example of, or includes aspects of, the corresponding element described with reference to FIGS. 7, 9, and 14.

According to some aspects, convolutional U-Net 1825 is implemented as software stored in memory unit 1715 in FIG. 17 and executable by processor unit 1705 in FIG. 17, as firmware, as one or more hardware circuits, or as a combination thereof. In some examples, convolutional U-Net 1825 is a type of CNN architecture used to process data using a skip connection. In some aspects, convolutional U-Net 1825 includes an encoder-decoder structure. For example, the encoder portion of the convolutional U-Net 1825 extracts features from an input (e.g., an image) in a low-level features in a high resolution (e.g., an input having a resolution of 256×256×3) and gradually extracts higher-level features in lower resolutions. At the bottleneck layer (e.g., the lowest CNN layer that has a resolution of 16×16×1024), the highest-level feature (such as abstract patterns, object structures) may be extracted.

Then, the decoding portion of the convolutional U-Net 1825 decodes the encoded features gradually from the lowest layer to the highest layer to generate an output feature (or an output image). In some aspects, the decoding layers perform upsampling and convolution to reconstruct the input data (e.g., an image) while preserving spatial details. In some cases, skip connection is used to directly passed the features from the encoding layers to the corresponding decoding layers, ensuring the preservation of fine-grained details of the input. Further detail on convolutional U-Net 1825 is described with reference to FIG. 12. Convolutional U-Net 1825 is an example of, or includes aspects of, the corresponding element described with reference to FIG. 9.

According to some aspects, image generation model 1830 is implemented as software stored in memory unit 1715 in FIG. 17 and executable by processor unit 1705 in FIG. 17, as firmware, as one or more hardware circuits, or as a combination thereof. According to some aspects, image generation model 1830 generates a refined image based on the keypoint information and the warped image. In some examples, image generation model 1830 injects the texture features at each of a set of layers. In some examples, image generation model 1830 generates a set of output images at the set of layers, respectively. In some examples, image generation model 1830 combines the set of output images to obtain the refined image.

According to some aspects, image generation model 1830 is configured to generate a refined image based on the keypoint information and the warped image. In some aspects, the image generation model 1830 includes a U-Net architecture. In some aspects, the image generation model 1830 includes a texture injection block configured to combine pose features and texture features. Image generation model 1830 is an example of, or includes aspects of, the corresponding element described with reference to FIGS. 7, 10, and 15.

According to some aspects, pose encoder 1835 is implemented as software stored in memory unit 1715 in FIG. 17 and executable by processor unit 1705 in FIG. 17, as firmware, as one or more hardware circuits, or as a combination thereof. According to some aspects, pose encoder 1835 encodes the keypoint information to obtain pose features. Pose encoder 1835 is an example of, or includes aspects of, the corresponding element described with reference to FIG. 10.

According to some aspects, texture encoder 1840 is implemented as software stored in memory unit 1715 in FIG. 17 and executable by processor unit 1705 in FIG. 17, as firmware, as one or more hardware circuits, or as a combination thereof. According to some aspects, texture encoder 1840 encodes the warped image to obtain texture features. Texture encoder 1840 is an example of, or includes aspects of, the corresponding element described with reference to FIG. 10.

According to some aspects, texture injection block 1845 is implemented as software stored in memory unit 1715 in FIG. 17 and executable by processor unit 1705 in FIG. 17, as firmware, as one or more hardware circuits, or as a combination thereof. According to some aspects, texture injection block 1845 combines the pose features and the texture features to obtain the refined image. Texture injection block 1845 is an example of, or includes aspects of, the corresponding element described with reference to FIGS. 10 and 11.

FIG. 19 shows an example of a computing device 1900 according to aspects of the present disclosure. The example shown includes computing device 1900, processor 1905, memory subsystem 1910, communication interface 1915, I/O interface 1920, user interface component 1925, and channel 1930.

In some embodiments, computing device 1900 is an example of, or includes aspects of, the image processing apparatus described with reference to FIGS. 1, 17, and 18. In some embodiments, computing device 1900 includes processor 1905 that can execute instructions stored in memory subsystem 1910 to obtain a subject image and a pose image, obtain keypoint information that associates a part of the subject image and a corresponding part of the pose image, generate a flow map indicating a transformation of the part of the subject image, and generate a warped image based on the flow map and the subject image.

According to some embodiments, processor 1905 includes one or more processors. In some cases, processor 1905 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1905 is configured to operate a memory array using a memory controller. In other cases, a memory controller is integrated into processor 1905. In some cases, processor 1905 is configured to execute computer-readable instructions stored in a memory to perform various functions. In some embodiments, processor 1905 includes special-purpose components for modem processing, baseband processing, digital signal processing, or transmission processing. Processor 1905 is an example of, or includes aspects of, the processor unit described with reference to FIG. 17.

According to some embodiments, memory subsystem 1910 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1910 is an example of, or includes aspects of, the memory unit described with reference to FIG. 17.

According to some embodiments, communication interface 1915 operates at a boundary between communicating entities (such as computing device 1900, one or more user devices, a cloud, and one or more databases) and channel 1930 and can record and process communications. In some cases, communication interface 1915 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1915.

According to some embodiments, I/O interface 1920 is controlled by an I/O controller to manage input and output signals for computing device 1900. In some cases, I/O interface 1920 manages peripherals not integrated into computing device 1900. In some cases, I/O interface 1920 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1920 or hardware components controlled by the I/O controller. I/O interface 1920 is an example of, or includes aspects of, the I/O module described with reference to FIG. 17.

According to some embodiments, user interface component 1925 enables a user to interact with computing device 1900. In some cases, user interface component 1925 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIG. 6.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a subject image and a pose image, wherein the subject image depicts an object and the pose image depicts a target pose;
obtaining keypoint information that associates a part of the subject image and a corresponding part of the pose image;
generating, using a warping model, a flow map indicating a transformation of the part of the subject image by generating a plurality of flow map features at a plurality of different resolutions at different layers of the warping model, respectively; and
generating a warped image based on the flow map and the subject image, wherein the warped image depicts the object with the target pose.

2. The method of claim 1, wherein obtaining the keypoint information comprises:
generating a first attention map and a second attention map based on the subject image and the pose image, respectively, wherein the keypoint information is based on the first attention map and the second attention map.

3. The method of claim 2, wherein obtaining the keypoint information comprises:
generating a first saliency map and a second saliency map based on the subject image and the pose image, respectively, wherein the keypoint information is based on the first saliency map and the second saliency map.

4. The method of claim 1, wherein:
the warping model is trained using a warping loss that includes a plurality of terms corresponding to the different layers of the warping model, respectively.

5. The method of claim 1, further comprising:
generating a refined image based on the keypoint information and the warped image.

6. The method of claim 5, wherein generating the refined image comprises:
encoding the keypoint information to obtain pose features;
encoding the warped image to obtain texture features; and
combining the pose features and the texture features to obtain the refined image.

7. The method of claim 6, wherein combining the pose features and the texture features comprises:
injecting the texture features at each of a plurality of layers;
generating a plurality of output images at the plurality of layers, respectively; and
combining the plurality of output images to obtain the refined image.

8. A non-transitory computer readable medium storing code for image processing, the code comprising instructions that, when executed by at least one processor, cause the at least one processor to perform operations comprising:
obtaining a subject image and a pose image, wherein the subject image depicts an object and the pose image depicts a target pose;
extracting keypoint information from the subject image and the pose image, wherein the keypoint information associates a part of the subject image and a corresponding part of the pose image;
generating, using a warping model, a warped image based on the subject image, the pose image, and the keypoint information, wherein the warped image depicts the object with the target pose; and
generating a refined image based on the keypoint information and the warped image.

9. The non-transitory computer readable medium of claim 8, the code further comprising instructions that, when executed by at least one processor, cause the at least one processor to perform operations comprising:
generating a flow map indicating a transformation of the part of the subject image by generating a plurality of flow map features at a plurality of different resolutions at different layers of the warping model, respectively.

10. The non-transitory computer readable medium of claim 8, wherein extracting the keypoint information comprises:
generating a first attention map and a second attention map based on the subject image and the pose image, respectively, wherein the keypoint information is based on the first attention map and the second attention map.

11. The non-transitory computer readable medium of claim 10, wherein extracting the keypoint information comprises:
generating a first saliency map and a second saliency map based on the subject image and the pose image, respectively, wherein the keypoint information is based on the first saliency map and the second saliency map.

12. The non-transitory computer readable medium of claim 8, wherein:
the warping model is trained using a warping loss that includes a plurality of terms corresponding to a different layer of the warping model, respectively.

13. The non-transitory computer readable medium of claim 8, wherein generating the refined image comprises:
encoding the keypoint information obtain pose features;
encoding the warped image to obtain texture features; and
combining the pose features and the texture features to obtain the refined image.

14. The non-transitory computer readable medium of claim 13, wherein combining the pose features and the texture features comprises:
injecting the texture features at each of a plurality of layers;
generating a plurality of output images at the plurality of layers, respectively; and
combining the plurality of output images to obtain the refined image.

15. A system comprising:
a memory component; and
a processing device coupled to the memory component, the processing device configured to perform operations comprising:
obtaining a subject image and a pose image, wherein the subject image depicts an object and the pose image depicts a target pose;
obtaining keypoint information that associates a part of the subject image and a corresponding part of the pose image;
generating, using a warping model, a flow map indicating a transformation of the part of the subject image by generating a plurality of flow map features at a plurality of different resolutions at different layers of the warping model, respectively; and
generating a warped image based on the flow map and the subject image, wherein the warped image depicts the object with the target pose.

16. The system of claim 15, wherein:
the warping model comprises a U-Net architecture.

17. The system of claim 15, further comprising:
an image encoder configured to generate a first attention map and a second attention map based on the subject image and the pose image, respectively, wherein the keypoint information is based on the first attention map and the second attention map.

18. The system of claim 15, further comprising:
an image generation model configured to generate a refined image based on the keypoint information and the warped image.

19. The system of claim 18, wherein:
the image generation model comprises a U-Net architecture.

20. The system of claim 18, wherein:
the image generation model comprises a texture injection block configured to combine pose features and texture features.
